(19) United States
(12) Patent Application Publication
(10) Pub. No.: US 2023/0343238 A1
(43) Pub. Date: Oct. 26, 2023

(54) TOILET TRAINING DEVICE

(71) Applicant: Gammit Tech LLC, Philadelphia, PA (US)

(72) Inventors: Troy Fink, Philadelphia, PA (US); Ranjith Premachandra, Woodland Hills, CA (US); Justin Babikian, Temple City, CA (US); Dinuki Suraweera, Philadelphia, PA (US)

(73) Assignee: Gammit Tech LLC, Philadelphia, PA (US)

(21) Appl. No.: 18/304,164

(22) Filed: Apr. 20, 2023

Related U.S. Application Data
(60) Provisional application No. 63/333,074, filed on Apr. 20, 2022.

(51) Int. Cl. G09B 19/00; E03D 9/00; G01S 7/481; G01S 17/86; G01S 17/89; H04R 1/02; H04R 3/00; G08B 5/38

(52) U.S. Cl. CPC G09B 19/0076; E03D 9/00; G01S 7/4813; G01S 17/86; G01S 17/89; H04R 1/028; H04R 3/00; G08B 5/38

(57) ABSTRACT

A toilet training device comprises a processor, a housing, several light-based time of flight (TOF) sensors, several LEDs, a sensor enclosure, and a clip. The clip attaches the device to the rim of a toilet bowl pointing the TOF sensors towards the water surface inside the toilet bowl. Each TOF sensor projects several light beams towards the toilet bowl, receives light reflected, makes measurements of the distance to the nearby object, and makes measurements of the signal strength of the reflected light. The processor generates a contour map and identifies one or more zones of interest as the water surface based on the distant measurements, determines excrement is released in the toilet bowl changes in the signal strength measurements are outside a signal strength range, and displays LED light patterns in response to determining the excrement is released in the toilet bowl.

### CLAIM OF BENEFIT TO PRIOR APPLICATIONS

This application claims the benefit of U.S. Provisional Patent Application Ser. No. 63/333,074, filed on Apr. 20, 2022. The contents of U.S. Provisional Patent Application 63/333,074 are hereby incorporated by reference.

### BACKGROUND

Toilet training has historically consisted of various do-it-yourself methods. Alternatively, modern toilet training devices may include real-time feedback elements such as lights and sound to reward the child for using the toilet. Some modern devices include electronic sensors to detect when a child has used the toilet and provide a form of reward (generally light or sound) to encourage good habits. Some systems require the purchase of a dedicated toilet which uses sensors to detect the waste matter released into the bowl and reward the child with sound, light or both. Other toilet-training systems attach to the rim of the toilet and use mechanical systems to detect a stream of urine in order to enable a reward.

### BRIEF DESCRIPTION OF THE DRAWINGS

The various embodiments of the present toilet training device now will be discussed in detail with an emphasis on highlighting the advantageous features. These embodiments depict the novel and non-obvious toilet training device shown in the accompanying drawings, which are for illustrative purposes only. These drawings include the following figures, in which like numerals indicate like parts:

FIG. 1A is a perspective view illustrating a toilet-training device attached to a toilet bowl, according to various aspects of the present disclosure;

FIG. 1B is a closeup view of the toilet-training device of FIG. 1A that is attached to the rim of the toilet bowl, according to various aspects of the present disclosure;

FIG. 2A illustrates a front and left perspective view, and FIG. 2B illustrates a back and right perspective view of the toilet training device, according to various aspects of the present disclosure;

FIG. 3A illustrates an exploded view of the toilet training device, according to various aspects of the present disclosure;

FIG. 3B illustrates a bottom exploded view of the sensor enclosure, the LED ring, the sensor(s), and the sensor enclosure cover of the toilet training device of FIG. 3A, according to various aspects of the present disclosure;

FIG. 4A illustrates the top view, FIG. 4B illustrates the right elevation view, FIG. 4C illustrates the bottom view, FIG. 4D illustrates the back view, and FIG. 4E illustrates the front view of the toilet training device, according to various aspects of the present disclosure;

FIG. 5 is a functional block diagram illustrating an example system for the electronic components of a toilet training device, according to various aspects of the present disclosure;

FIGS. 6A-6C illustrate a flowchart of an example process for detecting the use of a toilet, according to various aspects of the present disclosure;

FIG. 7 is a perspective view of an exemplary peripheral device of the toilet training device, according to various aspects of the present disclosure.

FIG. 8 is a functional diagram illustrating a contour map generated from the distance data received from the light-based TOF sensors, according to various aspects of the present disclosure;

FIG. 9 is a functional diagram illustrating the signal strength measurements for the zones of interest of FIG. 8, according to various aspects of the present disclosure.

FIGS. 10A-10C are graphs showing changes in the signal strength measurements received from the zones of interest that may indicate still water, water disturbance due to the use of the toilet, or water disturbance due to flushing of the toilet, according to various aspects of the present disclosure;

FIG. 11A is a right perspective view and FIG. 11B is a left perspective view of a toilet-training device used in a toilet bowl, according to various aspects of the present disclosure;

FIG. 12A and FIG. 12B illustrate right perspective views of the toilet training device, according to various aspects of the present disclosure;

FIG. 13 illustrates an exploded view of the toilet training device, according to various aspects of the present disclosure;

FIG. 14 illustrates different housing components of the toilet training device, according to various aspects of the present disclosure;

FIG. 15A illustrates the top view, FIG. 15B illustrates the back elevation view, FIG. 15C illustrates the left elevation view, FIG. 15D illustrates the front elevation view, and FIG. 15E illustrate the bottom view of the toilet training device, according to various aspects of the present disclosure;

FIG. 16 is a perspective view of an alternative embodiment that includes the toilet training device embedded into a toilet seat, according to various aspects of the present disclosure;

FIG. 17 illustrates an exploded view of the toilet training device of FIG. 16, according to various aspects of the present disclosure;

FIG. 18 provides details of the internal electronics of the toilet seat retrofit of FIG. 17, according to various aspects of the present disclosure;

FIG. 19A illustrates a perspective view and FIG. 19B illustrates an exploded view of an alternative embodiment of the toilet training device that includes a housing and a toilet seat retrofit, according to various aspects of the present disclosure;

FIG. 20 illustrates a perspective view of the mechanical enclosure of the toilet training device of FIGS. 19A-19B, according to various aspects of the present disclosure; and

FIG. 21 illustrates an exploded view of the electronic components of the toilet training device of FIGS. 19A-19B, according to various aspects of the present disclosure.

### DETAILED DESCRIPTION

One aspect of the present embodiments includes the realization that despite the use of sound and light in toilet training for many decades and introduction of several relatively new systems, no system has yet been designed to toilet train both males and females regardless of age, gender, or need to be toilet-trained sitting down or standing up. Furthermore, aside from intelligent “full toilet” systems, an easy retrofit or rim attachment device able to accurately detect an individual properly using the toilet despite the means of excreta does not exist. The “Full Toilet” based training systems may require the purchase of a child-sized toilet which must be cleaned after each use, thus making them tedious to maintain and unsanitary. The sensors used in the existing retrofit devices cannot correctly differentiate between the water surface and the walls of a toilet bowl, removing the necessary element of aiming one's excrement in the proper place for hygienic and normal toilet use. The sensors used in the existing retrofit devices lack sensitivity to properly distinguish between disturbances on the surface of the toilet bowl due to the waste matter being released into the bowl and the toilet being flushed. A male may also need to be re-trained on a regular toilet once the male is old enough to use the toilet in the standing position. Due to the large or bulky nature of the “full toilet” systems, and the ineffectiveness of the retrofit or rim attached systems, yet toilet-training remains a daunting task that has yet to see a viable solution.

The present embodiments, as described in detail below, solve the aforementioned problems by providing a unique use of a technology that solves these problems while improving the efficacy and user experience of toilet-training. This technology is capable of toilet training for either male or female users. There is no age limit for this product. In addition, the toilet training system of the present embodiments may also be used to “gamify” the training process, for example, to turn toilet training into a game or a form of entertainment. The toilet training device of the present embodiments detects precisely where the excrement is entering the bowl and if the user has properly aimed and successfully interfaced with the toilet while rewarding them to do so.

The core technology of the toilet training device of the present embodiments includes the use of one or more light-based time of flight (TOF) sensors to accurately detect when a user is releasing urine or feces into a toilet.

The toilet training device of the present embodiments may include a controller. The controller may include a processor (e.g., a microcontroller, a microprocessor, etc.) and one or more memory units.

The sensor(s) may be positioned inside or right above an off-the-shelf toilet bowl, facing downward towards the water towards the bottom of the toilet bowl. The reading of the TOF sensor(s) may then be used by the processor to map out the area of view of the sensor(s) into several regions, including areas of interest that include the surface of the water in the middle and sides of the toilet bowl.

The toilet training device of the present embodiments is able to detect any disturbances in a region of the toilet bowl water and accurately differentiate between the toilet being in use or being flushed. The primary method of detecting if the toilet is being used properly is to examine the disturbances in the water. By using the light-based TOF sensor(s) to monitor the water, the toilet training device of the present embodiments accurately determines when the toilet is in proper use. In contrast to the sensors used in the prior toilet training systems, the light-based TOF sensors are much more effective in detecting disturbances in the bowl and may detect whether a person is using the toilet properly while rewarding them to do so. The light-based TOF sensors may be infrared TOF sensors, visible or invisible laser based TOF sensors, light detection and ranging (LIDAR) sensors, and/or visible light TOF sensors.

In addition, since the toilet training device of the present embodiments detects where the disturbances are in the bowl, the toilet training device may gauge the aim control of the user and may provide feedback to correct it. Other sensors used in the present embodiments may include proximity, pressure, ambient light, ultrasonic, and/or multi-spectral light sensors. These sensors may be used for various other purposes, including detecting if a person is sitting down on the toilet, if the toilet lid is being open or closed, or gauge the ambient lighting conditions in the bathroom.

The toilet training device may be securely attached to the toilet, with the light-based TOF sensor(s) head(s) facing the inside of the bowl. The device housing secures the device onto the toilet. The housing is designed in a way to house the device electronics, allowing the sensor(s), actuators and batteries to be swapped out by a person, while providing safe operation of the device in its intended environment.

The toilet training device, in some embodiments, may be enabled via an activation switch, such as a push button switch. The toilet training device, in some embodiments, may be equipped with proximity sensors to detect the toilet lid being open/closed or to detect an approaching person to automatically enable or disable the toilet training device. These features allow the device to automatically turn on/off for energy efficiency as well as to provide additional functionality based on lid position and user proximity. The device may also be configured to be set up as a night light when not in use as a toilet trainer. The night light feature would use sensors to detect ambient light and enable/disable the night light. The night light may be one of the toilet training device's light emitting diodes (LEDs) or may be an external light activated by the toilet training device.

Once the toilet training device is enabled, the light-based TOF sensor(s) may continually scan the toilet bowl to detect usage. If proper toilet usage is detected, the device may enable various forms of actuation as part of the reward-based program. These actuations may include one or more of the following. Enabling/disabling LED lighting inside and outside the toilet bowl, enabling/disabling sound and music from the device, enabling/disabling an application running on an external electronic device (e.g., a smartphone or tablet) via wire or wirelessly, and/or enabling and disabling a peripheral device (e.g., a wearable device, a toy or other animatronic object, etc.) via wire or wirelessly. The toilet training device may also be set up to provide feedback after the toilet has been used.

The toilet training device may include a processor (e.g., a microcontroller or a microprocessor) and one or more memory units. The toilet training device may include one or more wireless transceivers such as, Wi-Fi, Bluetooth, and/or other wireless communication transceivers. The wireless communication connectivity may allow the device to connect to an electronic device, such as a peripheral device (e.g., a wearable device, a toy or other animatronic object, etc.), a smartphone, a tablet, or other wireless devices for communicating usage data and analytics, and for controlling peripheral devices and/or the toilet training device. The processor, the memory unit(s), and the wireless transceiver(s) may be on a controller board.

In some alternative embodiments, the sensors, the actuator, the controller, and other device-related electronics may be embedded within a toilet seat. These toilet seats may be retrofitted onto various off-the-shelf toilet bowls and may operate via battery power and/or optionally with AC wall power. The toilet seat may include all sensors described above, including the waste detection sensor(s) as well as the additional sensors to detect a person sitting on the toilet seat, and/or to detect the position of the seat.

One or more LEDs and/or one or more speakers may be embedded into the seat along with an optional seat vibrator. The seat may optionally include one or more wireless transceivers, such as Wi-Fi, Bluetooth, and/or other wireless communication transceivers for remote data transfer and device actuation. The toilet seat retrofit kit may optionally include pressure sensors capable of measuring the weight of a user sitting on the toilet seat (e.g., assuming the feet are off the ground) and/or the pressure applied by a person sitting on the toilet seat. The retrofit seat may be used in both seat-up and seat-down positions as well as being set up as a night light when not in use.

In some alternative embodiments, an electronics assembly box may house the electronics and may be attached onto the side of the toilet. The electronics assembly box, in some embodiments, may be secured onto the side of a toilet via bolts used for the toilet seat. The waste detection sensor electronics may then be attached either to the toilet seat or to the electronics assembly box. The electronics assembly box may be battery powered and/or AC wall powered.

The toilet training device encourages good habits and proper use of a toilet through the use of visual and audible rewards. The aspects of the design include the optical TOF waste detection sensor(s), bowl illumination multicolored LEDs, proximity detection sensors, control board, batteries, detachable housing, wireless connectivity (e.g., Wi-Fi, Bluetooth, etc.), optional peripheral wireless devices that may be actuated as a reward (e.g., a wearable device, a toy or other animatronic object, etc.), an application that enables, etc.).

The remaining detailed description describes the present embodiments with reference to the drawings. In the drawings, reference numbers label elements of the present embodiments. These reference numbers are reproduced below in connection with the discussion of the corresponding drawing features.

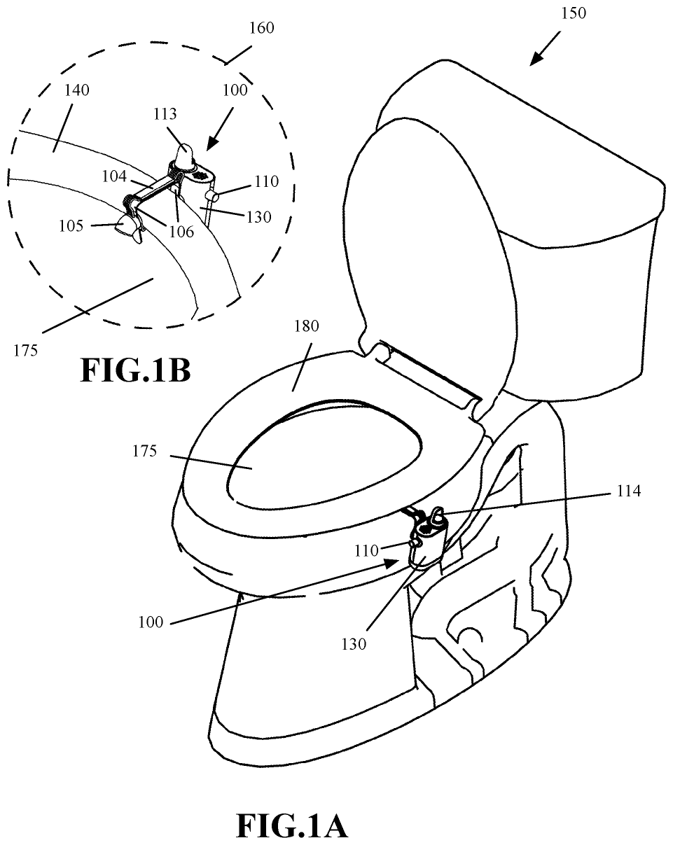

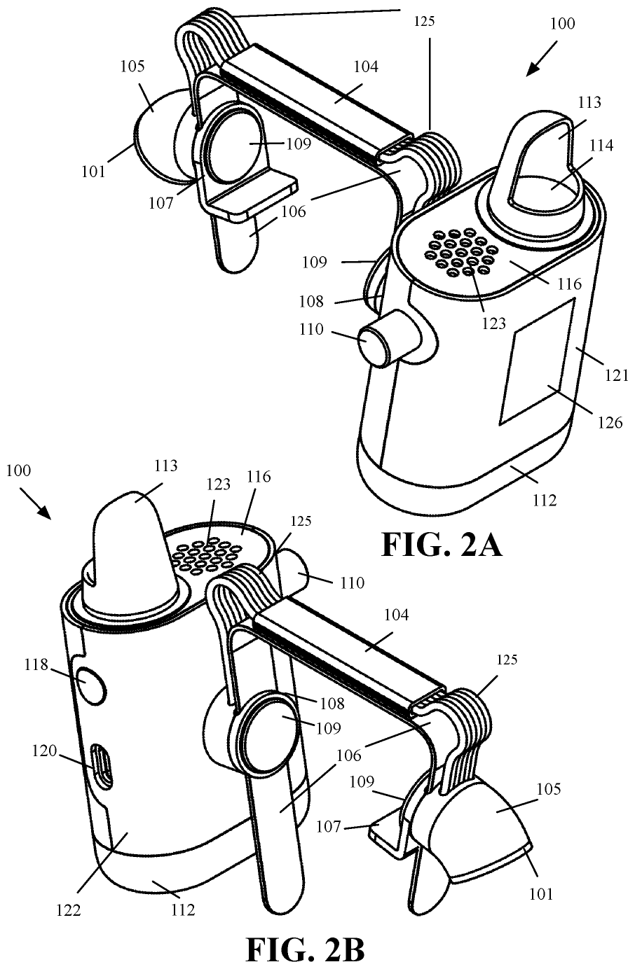

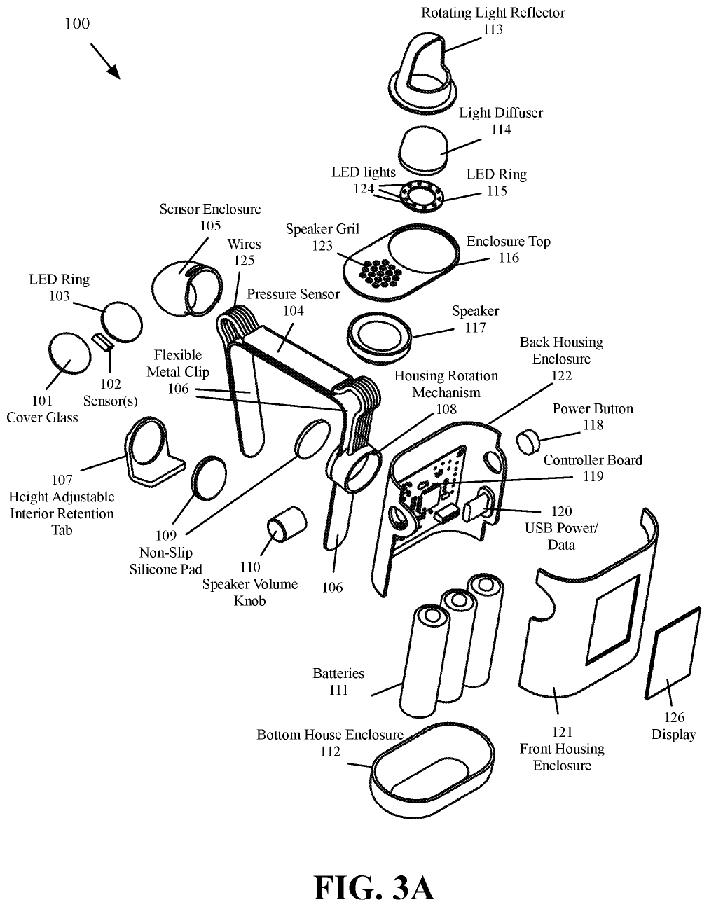

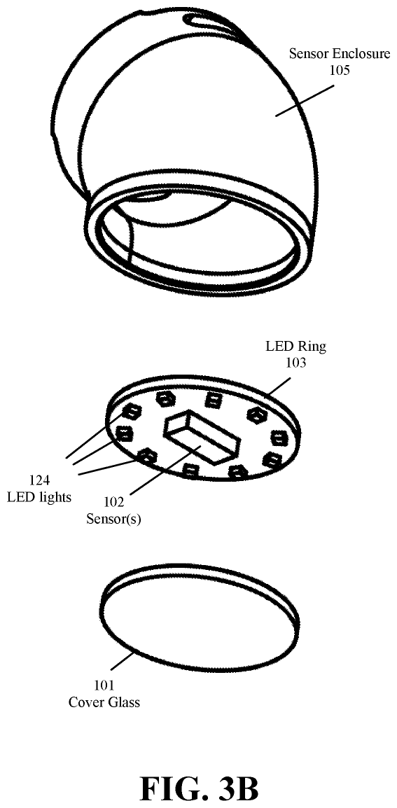

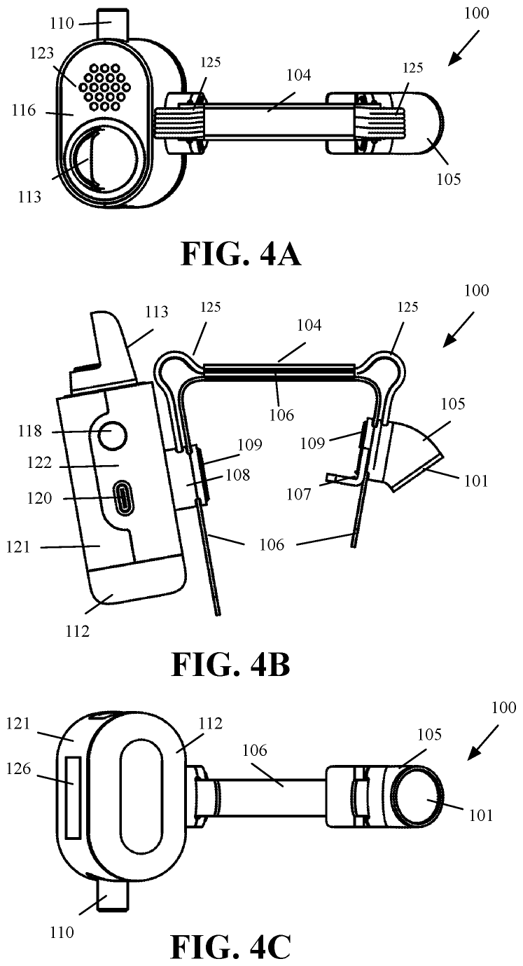

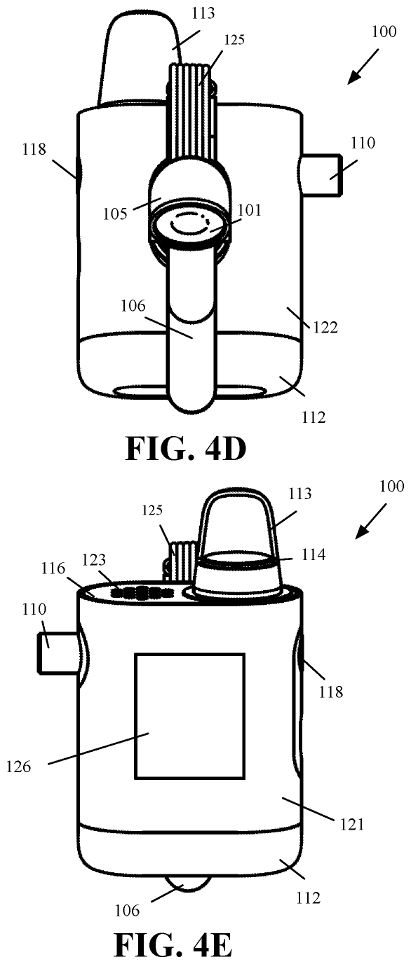

Some of the present embodiments provide a toilet training device (also referred to as a potty training device) for either male or female users. There is no age limit for this device. FIG. 1A is a perspective view illustrating a toilet-training device attached to a toilet bowl, according to various aspects of the present disclosure. FIG. 1B is a closeup view of the toilet training device of FIG. 1A that is attached to the rim of the toilet bowl, according to various aspects of the present disclosure. FIG. 2A illustrates a front and left perspective view, and FIG. 2B illustrates a back and right perspective view of the toilet training device, according to various aspects of the present disclosure. FIG. 3A illustrates an exploded view of the toilet training device, according to various aspects of the present disclosure. FIG. 3B illustrates a bottom exploded view of the sensor enclosure, the LED ring, the sensor(s), and the sensor enclosure cover of the toilet training device of FIG. 3A, according to various aspects of the present disclosure. FIG. 4A illustrates the top view, FIG. 4B illustrates the right elevation view, FIG. 4C illustrates the bottom view, FIG. 4D illustrates the back view, and FIG. 4E illustrates the front view of the toilet training device, according to various aspects of the present disclosure.

With reference to FIGS. 1A-1B, 2A-2B, 3A-3B, and 4A-4E, the toilet-training device 100 may be housed within a housing 130. The housing 130 may be attached to a toilet 150. FIG. 1A shows the toilet seat in the down positions and FIG. 1B shows the toilet seat in the up position. As shown in the expanded view 160 of FIG. 1B, the toilet-training device 100 may be securely attached to the rim 140 of the off-the-shelf toilet 150 with the head of the sensor(s) 102 (FIG. 3) that is/are located inside the sensor enclosure 105 facing the inside of the bowl 175. As described below, the sensor(s) 102 may be used to detect whether the toilet is being used.

The housing 130 may be designed to house the device electronics, allowing for swapping out of sensors, actuators, and batteries, while providing safe operation of the device 100 in its intended environment. The clip 106 attached to the toilet training device housing 130 may secure the toilet training device 100 onto the toilet 150. The clip 106 may include two ends where one end that is attached to the rotating mechanism 108 may grab the outside of the toilet rim 140 and the other end that is attached to the height adjustable retention tab 107 may grab the inside of the toilet rim 140. The non-slip silicone pads 109 may provide a non-slipping grip of the toilet bowl rim 140.

The clip 106, in some embodiments, may be a flexible clip made of metal to provide ease of attachment and durability. The clip 106 may be connected to the housing 130 by the housing rotation mechanism 108 that may allow rotating the housing for proper adjustment after the toilet training device is connected to the rim 140 of the toilet 150. The height adjustable retention tab 107 may be used to adjust the height of the sensor enclosure 105 after the toilet training device is connected to the toilet rim 140. The housing rotation mechanism 108 and the height adjustable retention tab 107 may include the corresponding non-slip silicone pads 109 to provide better grip to the toilet rim 140.

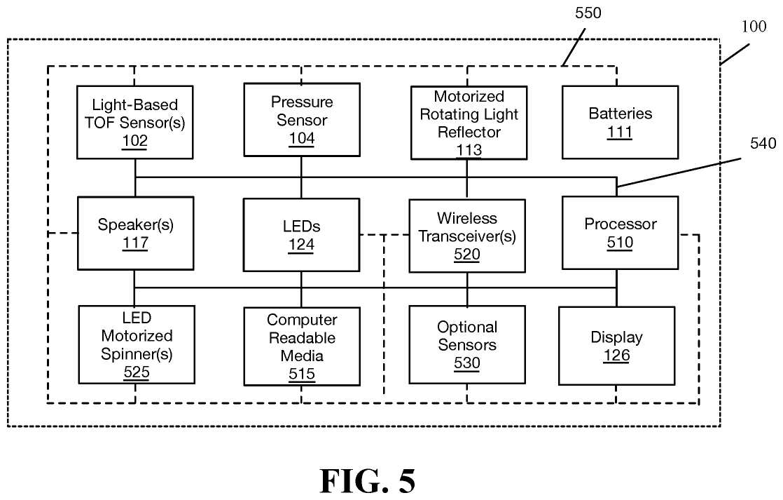

With reference to FIGS. 3A-3B, the toilet training device 100 may include a sensor enclosure cover 101, one or more waste (or excrement) detection light-based TOF sensors 102, one or more LED rings (two LED rings 103 and 115 are shown), a pressure sensor 104, a sensor enclosure 105 for the light-based TOF sensor(s) 102, a flexible metal clip 106, a height adjustable retention tab 107 a housing rotation mechanism 108, a non-slip silicone pad 109, a speaker volume knob 110, one or more batteries 111, a bottom portion 112 for the housing enclosure 130 (FIG. 1A), a rotating or fixed light reflector 113, a light diffuser 114, a top portion 116 for the housing enclosure 130 that may include a speaker grill 123, a speaker 117, a power button 118, a controller board 119 with a plurality of electronics components (e.g., and without limitations, a processor, computer readable media, one or more wireless transceivers, etc.), a USB port for receiving power and exchanging data, a front portion 121 for the housing enclosure 130, a back portion 122 for the housing enclosure 130, and/or a display 126. As shown in FIGS. 3A-3B, each LED ring 103 and 115 may include several single color and/or multicolored LEDs 124. The wires 125 may connect the batteries 111 and the processor 510 (FIG. 5) of the toilet training device to the electronic components, such as the LED ring 103 and the sensor(s) 102 inside the sensor enclosure 105.

It should be noted that in FIG. 3A, the sensor(s) 102 is/are shown separate from the LED ring 103. However, in some embodiments, the LED ring 103 and the sensor(s) are included in a printed circuit board (PCB). In these embodiments, the sensor(s) 102 may not be visible in the top view of FIG. 3A. The bottom view of FIG. 3B shows the position of the sensor(s) 102 on the LED ring 103. It should be noted that some embodiments may include LEDs that are positioned outside of the housing 130. Some embodiments may include LEDs that are not positioned on an LED ring.

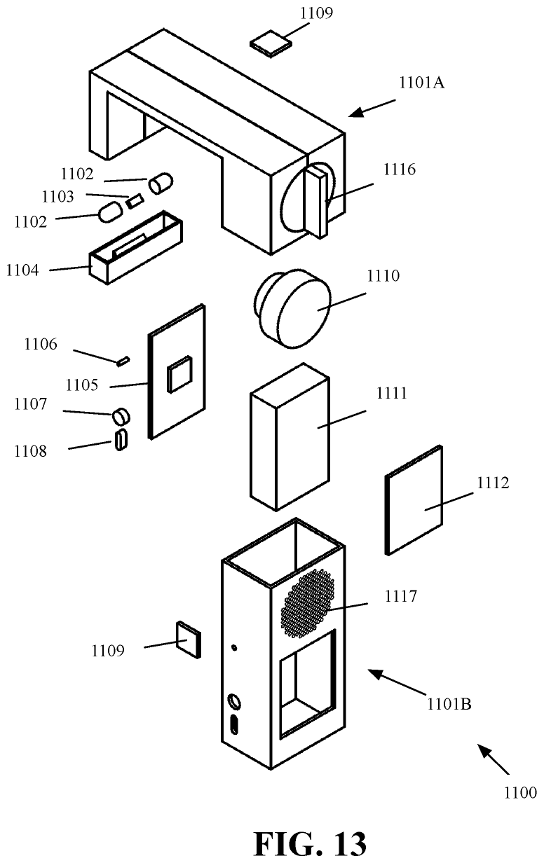

As shown in FIG. 13A, the housing 130 (FIG. 1A) may include several different sections 112, 116, 121, and 122 to provide ease of access to different components of the toilet training device 100. The speaker(s) 117 may be used to play sound or music to interact with the user. The toilet training device 100 may include a speaker grille 123 to allow the speaker(s) 110 sound to exit the housing of the device. The speaker(s) volume may be adjusted by the speaker volume knob 110. The speaker volume knob 110, in some embodiments, may also serve as a push button, which when depressed, cycles light and sound combinations.

The optional display 126 may be, for example, and without limitations, a liquid crystal display (LCD) screen to provide a user with additional functionality. The LCD screen, in some embodiments, may be touch sensitive.

The light diffuser 114 may diffuse the light generated by the LEDs 124 on the LED ring 115. The LED rings 103 and/or 115, in some embodiments, may be motorized and may rotate when the LEDs 124 are on. The light reflector 113 may be rotatable or fixed. In some embodiments, the light reflector 113 may be manually rotated by a person. In some embodiments, the light reflector 113 may be motorized and may rotate when the LEDs 124 on the LED ring 115 are on for an additional visual effect. The sensor enclosure cover 101 may be made of a transparent material, for example and without limitations, glass or plastic. The sensor enclosure cover 101 may be used to protect the sensor(s) 102 inside the sensor enclosure 105. The sensor enclosure cover 101 may diffract the light that passes through it. The sensor enclosure cover 101 may provide a diffusing effect for the LED lights 124 on the LED ring 103 when the LED lights are turned on.

The power for the electronics onboard the toilet training device 100 may be supplied by a battery pack 111 or a power supply, which may include one or more batteries, or a power converter to be used with an external power supply. The power to the toilet training device 100 may be manually turned on or off by the power button 118. The power to the toilet training device 100 may be controlled by the processor of the toilet training device. The processor may turn off power to some components of the toilet training device in order to save power in a low power mode.

The device 100 and the housing 130 are designed for easy attachment and detachment of various heads (sensor units) or various LED actuators. The waste detection sensor(s) 102, in some embodiments, may be included in the sensor enclosure 105. The terms waste or excrement is used herein to refer to both urine and feces. The sensor enclosure 105 may be detachable from the housing 130 to swap different waste detection sensors. As shown in FIG. 1B, after the toilet training device 100 is installed on a toilet, the waste detection sensor enclosure 105 may be positioned such that the waste detection sensor(s) 102 located inside the waste detection sensor housing 105 may face the inside of the bowl 175.

The pressure sensor 104 may measure the pressure applied by the toilet seat 180 and may be used to determine whether the toilet seat 180 is up or down. As described below, moving the toilet seat up or down may result in the sensor enclosure 105 to move, requiring a recalibration to determine the distance to the water surface in the toilet bowl and/or to readjust the zones of interest. The waste detection sensor(s) 102, in some embodiments, may include TOF sensor(s) that may be used to detect if a person is releasing urine or feces into a toilet. A light-based TOF sensor (also referred to as time of flight of light sensor) may use light (e.g., infrared TOF sensors, visible or invisible (e.g., infrared) laser based TOF sensors, LIDAR sensors, and/or visible light TOF sensors) to provide depth information. The infrared light-based or infrared laser light-based TOF sensors provide the additional advantage of not being visible to human eyes.

The TOF sensor(s) of the present embodiments may emit light signals, which may hit the top surface of the water in the toilet bowl 175. As shown in FIGS. 1A and 1B, the toilet training device 100 may be installed such that the TOF sensor(s) may be positioned inside or right above the toilet bowl 175, facing downward towards the water surface at the bottom of the toilet bowl. The light emitted by the TOF sensor(s) may hit the water surface and may return to the TOF sensor(s). The time it takes for the light to bounce back is then measured to provide depth-mapping capabilities.

One of the technical advantages of using a light-based TOF sensor over an ultrasonic TOF sensor is that the distance ranging resolution and accuracy of the light-based TOF sensor are significantly better. Changes in the toilet bowl water when in use are minute, and ultrasonic (or acoustic) based TOF sensors are not capable of providing the high accuracy needed to measure these minute changes accurately and reliably. Detecting these changes in the water also needs a relatively high resolution, which is difficult to achieve with ultrasonic sensors.

Another technical advantage of the light-based TOF sensors over the acoustic based TOF sensors is providing the signal strength of the reflected light. The light-based TOF sensors provide the signal strength by measuring the number of photons received by the sensor. The TOF method measures the distance between a TOF sensor and an object, based on the time difference between the emission of a signal and its return to the sensor, after being reflected by an object. A TOF sensor transmits multiple photons of light (e.g., in the form of pulses of light) towards the object and counts how long it takes for these light pulses to get back. The TOF sensor also counts the number of photons received back. Generally, whenever there is a change in a reflective surface such as water, the number of photons received either increases or decreases dramatically when there is movement.

This phenomenon is further improved by using multiple TOF sensors. Since there are multiple photon transmitters and receivers, some receivers may get bombarded by many photons even from other transmitters and some receivers may see drastic decreases due to the waves/ripples in the water. Such a scheme is not achievable by the ultrasonic TOF sensors because the ultrasonic TOF sensors emit a pulse and wait for an echo pulse. Monitoring the signal strength of these echo pulses does not provide enough information to determine movements in the water. The resolution and refresh rate of the ultrasonic TOF sensors is not sufficient to get a proper signal strength. Using multiple ultrasonic sensors may cause the sensors to interfere with each other and fail to work properly.

FIG. 5 is a functional block diagram illustrating an example system for the electronic components of a toilet training device, according to various aspects of the present disclosure. With reference to FIG. 5, the electronic components of the toilet training device may include a processor 510, one or more computer readable media units 515, one or more wireless transceivers 520, one or more batteries 111, one or more optional LED motorized spinners 525, a pressure sensor 104, an optional motorized rotating light reflector 113, one or more LEDs 124, one or more light-based TOF sensors 102, one or more speakers 117, a display 126, and one or more optional sensors 530.

The processor 510, the computer readable media unit(s) 515, and the wireless transceiver(s) 520, in some embodiments, may be on the controller board 119 of FIG. 13A. The batteries 111, in some embodiments, may be rechargeable. The USB power and data port 120 (FIG. 3A) may be used to recharge the batteries. The wireless transducer(s) 510 may include, for example and without limitations, Bluetooth, Wi-Fi, and/or Xbee transducers. The wireless transducer(s) 510 and/or the USB port 120 (FIG. 3A) may allow the processor 510 to communicate with one or more external devices, such as smartphones, tablet computers, laptop computers, desktop computers, etc.

The processor 510 may communicate with other electronic components of the toilet training device 100 through the wires 540. The batteries may provide power of the other electronic components of the toilet training device 100 through one or more wires 550. It should be noted that the wires 550 are conceptually shown in FIG. 5 and the processor 510 may be connected to other electronic components of the toilet training device 100 through one or more busses and/or through individual wired connections.

The processor 510 may be, for example, and without limitations, a microprocessor or a microcontroller. The computer readable media 515 may be volatile memory and non-volatile memory to store data and/or computer readable instructions. The computer readable media 515 may be non-transitory computer readable media. The computer readable media 515 may include different types of memory units, such as, read-only-memory, volatile read-and-write memory, and/or non-volatile read-and-write memory. The read-only-memory may store static data and instructions that are needed by the processor. The non-volatile read-and-write memory may store instructions and data even when the power to the non-volatile memory is off.

The volatile read-and-write memory device may be random access memory and may be used as system memory. The system memory may store some of the instructions and data that the processor needs at runtime. In some embodiments, the processes of the present embodiments may be stored in the system memory, the non-volatile memory, and/or the read-only memory. From these various memory units, the processor 510 may retrieve instructions to execute and data to process in order to execute the processes of some embodiments.

The light-based TOF sensors 102, the pressure sensor 104, the optional motorized rotating light reflector 113, the LEDs 124, the speaker(s) 117, and the display 126 may be the same as the corresponding items in FIGS. 3A and 3B. Some embodiments may optionally include one or more LED motorized spinner(s) 525 to rotate the LED ring 103 and/or the LED ring 115 of FIG. 3A.

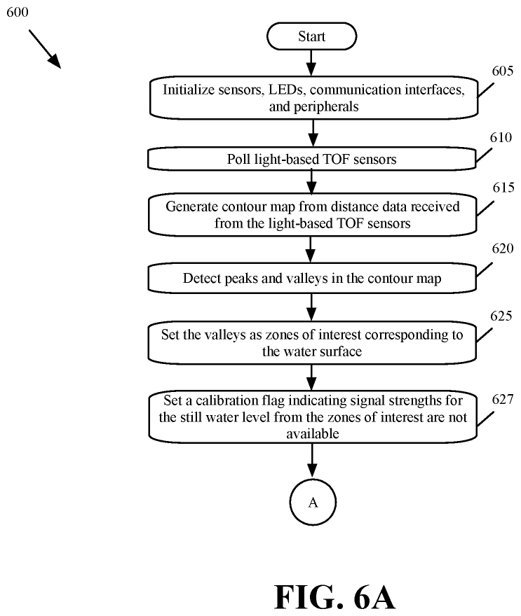

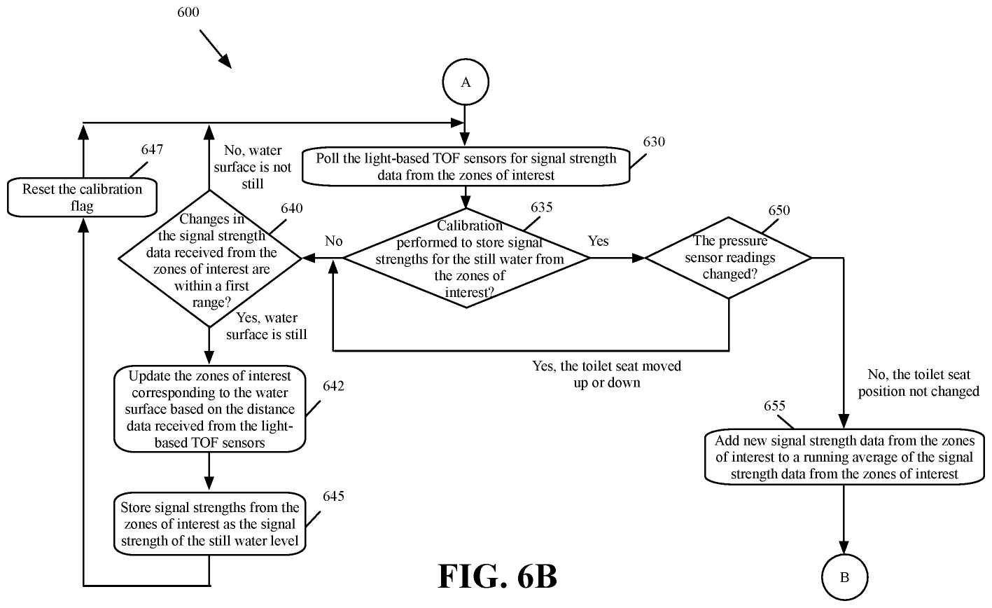

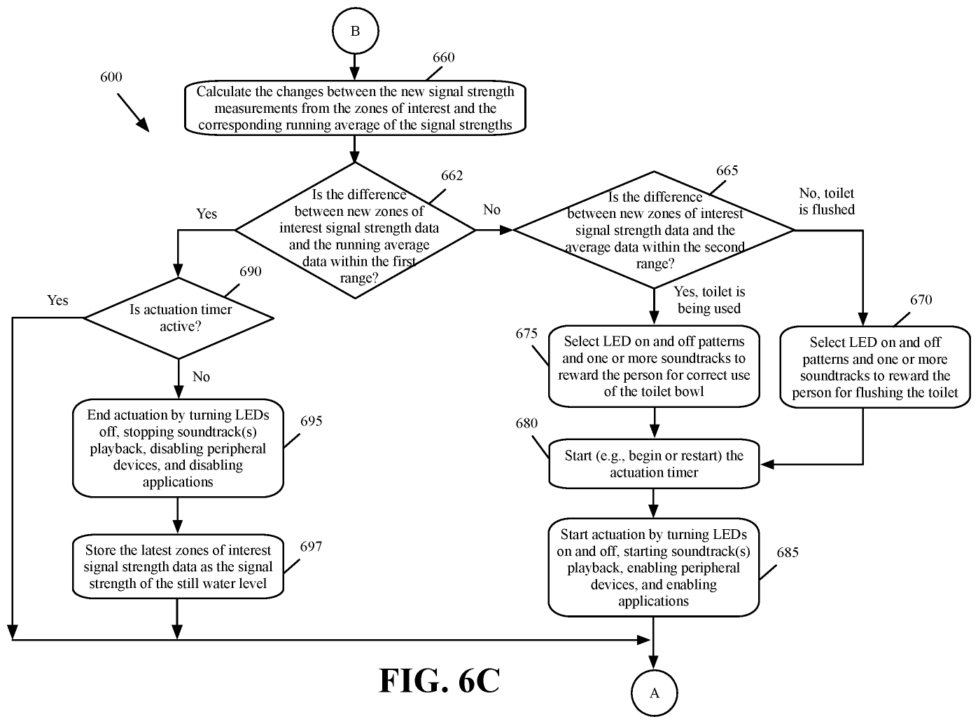

The light-based TOF sensor(s) may include one or more Single Photon Avalanche Diode (SPAD) sensor(s), LIDAR(s), laser distance sensor(s), photodiode(s), avalanche photodiode(s), phototransistor(s), etc. Some embodiments may use only one light-based TOF sensor, other embodiments may use two or more light-based TOF sensors. FIGS. 6A-6C illustrate a flowchart of an example process 600 for detecting the use of a toilet, according to various aspects of the present disclosure. The process 600, in some of the present embodiments, may be performed by a processor of the toilet training device 100.

With reference to FIGS. 6A-6C, the sensors, LEDs, communication interfaces, and peripherals may be initialized (at block 605). The LEDs, in some embodiments, may include multicolor LEDS. The multicolor LEDs, in some embodiments, may be chainable and individually addressable full-color RGB LEDs. In other embodiments, the LEDs may be single color LEDs or some LEDs may be single color and other LEDs may be multicolor. As a part of the initialization, the LEDs may be set to an initial state (e.g., turned off or set to an initial color).

The light-based TOF sensors 102, in some embodiments, may be calibrated for crosstalk if the sensor enclosure cover 101 is used. In the embodiments that use multiple TOF sensors, multiple sensors may be transmitting cross beams into the bowl and may receive the bounce backs that may hit the transparent material of the sensor enclosure cover 101 during the transmission and reflection and may get diffracted. As such, multiple sensors may receive the diffracted light that was sent out by a sensor. Some embodiments may perform cross talk calibration for each sensor by sending one or more signals to the sensor to transmit a light beam (e.g., a pulse of light) and receive the light reflection back. The time the light is reflected back may be stored and the offset and angle of the light that the sensor gets back may be determined and may be used to calibrate the sensor's readings.

The waste detection light-based TOF sensors, in some embodiments, may also sense the ambient light. A non-limiting example of TOF sensors that also sense ambient light is the SPAD sensors. The processor of the toilet training device may receive the ambient light readings from the TOF sensors and may turn some or all LEDs 124 on the LED ring 103 on when the ambient light level is less than a threshold. The LED(s) 124 used for ambient light may be turned on as a part of the initialization and/or during the operation of the toilet training device when the ambient light level goes below the threshold. The LED(s) 124 used for ambient light may be turned off as a part of the initialization and/or during the operation of the toilet training device when the ambient light level becomes equal or goes above the threshold.

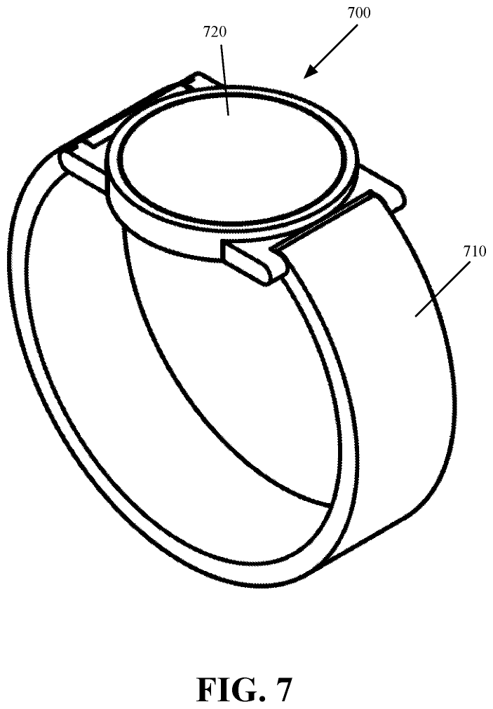

The toilet training device may communicate with one or more peripheral devices that may need initialization. FIG. 7 is a perspective view of an exemplary peripheral device 700 of the toilet training device, according to various aspects of the present disclosure. The peripheral device 700 of FIG. 7 is one example of the peripheral devices that may be used in conjunction with the toilet training devices of the present embodiments.

With reference to FIG. 7, peripheral device 700 may be wearable and may include a wristband 710 and a display 720. The display 720 may be an LCD or LED display. The peripheral device 700 may include a processor, computer media, a wireless transceiver, and one or more batteries, which may respectively be similar to the processor, computer media, wireless transceiver, and batteries of FIG. 5.

The wireless transceiver of the peripheral device 700 may be capable of communicating with the toilet training device 100 mounted on the toilet. When toilet activity is detected, the processor 510 of the toilet training device 100 may communicate (e.g., via RF/Bluetooth) with the processor of the peripheral device 700, which may then light up with built in LED's and/or may play music as a reward. The peripheral device 700 may optionally vibrate and be programmable to remind a child when to use the toilet. The peripheral device 700 may also collect data/metrics on toilet usage, such as frequency, timing, etc., which may be available to download into an electronic device, such as a smartphone, a tablet computer, a desktop computer, a laptop computer, a server, etc.

Some of the toilet training device's peripheral devices may need initialization. For example, the sound or audio coder-decoder (CODEC) and the input/output (IO) parameters of the speaker may need initialization. As a part of the initialization, the processor of the toilet training device may go through a map of the 10 in software and may set the processor's general purpose IO (GPIO) for different buttons and input or output devices. Some embodiments may confirm the completion of initialization by generating an audio and/or visual message. For example, some embodiments may turn on one or more LEDs 124 and/or may play a sound or a message (for example, through the speaker(s) 117) to confirm the completion of initialization.

The following is a non-limiting example of the initialization that may be performed by some embodiments in block 605 of FIG. 6A.

Begin code and initialize microcontroller peripherals

Set up one or more SPAD's (Single photon avalanche diode)
Load Firmware into sensor/s
Set up software comms with SPAD or sensor (I2C/SPI/TTL)
Set up Physical IR Filters
Set up Diffractive optics

Reset calibration parameters for TOF sensor(s)

Find offsets and run calibration routine

Calibrate for crosstalk if sensor enclosure cover is used

Set up single or multizone measurements 1×1 or 2×2, 4×4, 8×8, etc., if one or many sensors is/are used

Set up for continuous ranging and set up ranging frequency

Set up audio codec

Validate sound clips

Initialize Speaker(s)
Set up communication protocol
Set up inputs/outputs

Initialize Buttons

Initialize LED motorized spinner (Optional)
Set up motor inputs & outputs

Initialize LEDs
Set up multicolored LEDs and communication protocols
Set up single colored LEDs

Initialize communication protocols such as Bluetooth and/or Xbee

Set up interrupts for peripherals and sensors.

Initialize seat pressure sensor to detect if seat is up/down
Set up communication interface
Set up inputs and outputs

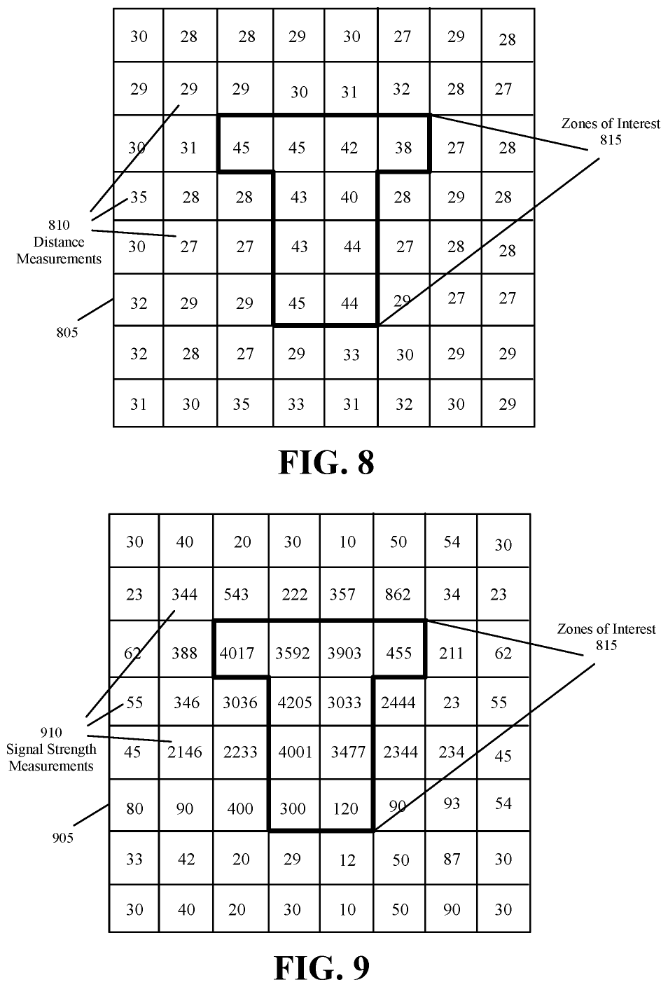

Referring back to FIGS. 6A-6C, the light-based TOF sensor(s) may be polled (at block 610). For example, the processor 510 (FIG. 5) may receive the distance and signal strength readings from the light-based TOF sensor(s) 102 (FIG. 3A-3B, 5). A contour map may be generated (at block 615) from the distance data received from the light-based TOF sensors. FIG. 8 is a functional diagram illustrating a contour map generated from the distance data received from the light-based TOF sensors, according to various aspects of the present disclosure.

With reference to FIG. 8, the 8×8 contour map 805 is made based on the distance measurements 810 received from 64 light-based TOF sensors. Other contour maps may be generated for any number of one or more light-based TOF sensors. Each square 810 in the contour map 805 shows the distance measurement received from a corresponding light-based TOF sensor. In the example of FIG. 8, the measured distances are rounded up to centimeter for simplicity. In operation, the light-based TOF sensors may provide distance readings with accuracy in the millimeter range.

With reference to FIGS. 6A-6C, the peaks and valleys in the contour map may be detected (at block 620). For example, the peaks may correspond to the smaller distance readings and the valleys may correspond to the larger distance readings. The valleys may then be set (at block 625) as zones of interest corresponding to the water surface.

As shown in FIG. 8, an area 815 (shown with the thicker lines) in the contour map may be identified as the toilet bowl water level. The area 815 may be identified as an area with the lowest points in the toilet bowl based on the largest distance measurements received from the light-based TOF sensors. The area 815 may be set as zones of interest since the readings from the light-based TOF sensors pointing to the zone of interest may be used to determine whether the water surface is disturbed, which may indicate whether the toilet is being used or whether the toilet is flushed.

With further reference to FIGS. 6A-6C, a calibration flag may be set (at block 627) indicating signal strengths for the still water level from the zones of interest are not available. The signal strengths for the still water level are required in order to determine whether the water surface is disturbed due to the use of the toilet by a person or flushing the toilet.

The light-based TOF sensors may be polled (at block 630) for signal strength data from the zones of interest. For example, the processor 510 (FIG. 5) may receive the distance and signal strength readings from the light-based TOF sensor(s) 102 (FIG. 3A-3B, 5). FIG. 9 is a functional diagram illustrating the signal strength measurements for the zones of interest of FIG. 8, according to various aspects of the present disclosure, according to various aspects of the present disclosure.

FIG. 9 shows the signal strength measurements 910 received from the same 64 light-based TOF sensors that provided the distance measurements of FIG. 8. Each square 910 in FIG. 9 shows the signal strength measurement received from a corresponding light-based TOF sensor. The signal strength measurement for the zone of interest 815 correspond to the signal strength of light beams reflected from the surface of the toilet bowl.

A technical advantage of the light-based TOF sensors of the present embodiments over the acoustic based TOF sensors is providing the signal strength of the reflected light. The light-based TOF sensors provide the signal strength by measuring the number of photons received by the TOF sensor. The TOF sensor transmits multiple photons of light (e.g., in the form of pulses of light) towards the object and counts how long it takes for these light pulses to get back. The TOF sensor also counts the number of photons received back. Whenever there is a change in a reflective surface such as water, the number of photons received either increase or decrease dramatically when there is movement. Since the disturbances on the water surface due to the use of the toilet by a person is usually in the millimeter range and is hard to detect by distance measurements, the changes in the signal strength due to the use of the toilet are significant and the changes may be accurately measured by the light-based TOF sensors.

This phenomenon is further improved by using multiple TOF sensors. Since there are multiple photon transmitters and receivers, some receivers will get bombarded by many photons even from other transmitters and some will see drastic decreases due to the waves/ripples in the water. Such a scheme is not achievable by the ultrasonic TOF sensors because the ultrasonic TOF sensors emit a pulse and wait for an echo pulse. The resolution and refresh rate of the ultrasonic TOF sensors is not sufficient to get a proper signal strength. Using multiple ultrasonic sensors is not possible unless each sensor emits a different frequency pulse, otherwise the sensors interfere with each other and fail to work properly.

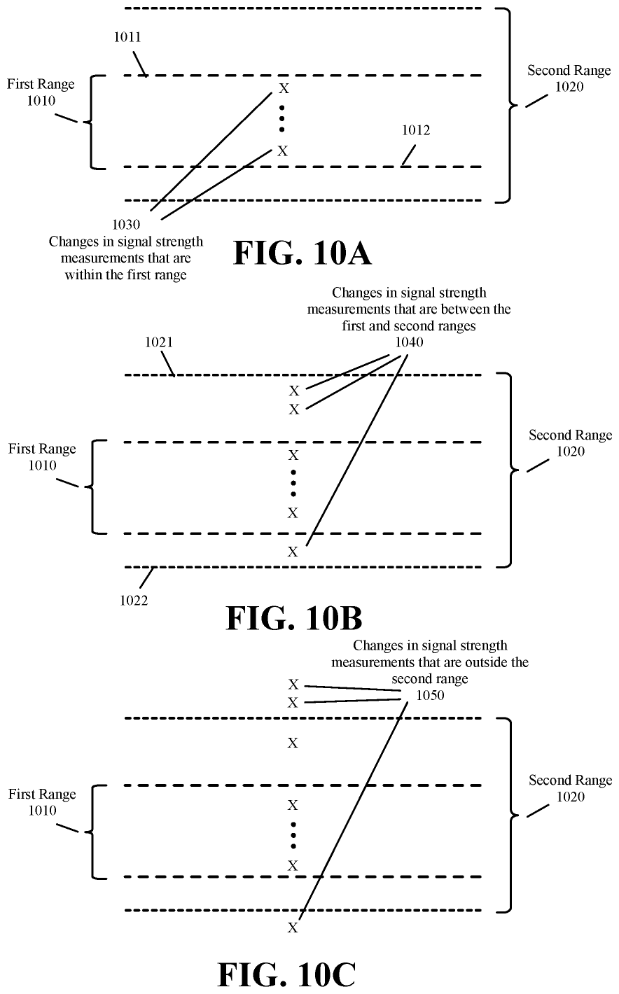

With reference to FIGS. 6A-6C, a determination may be made (at block 635) whether calibration is performed to store signal strengths for the still water from the zones of interest? If yes, the process 600 may proceed to block 650, which is described below. Otherwise, a determination may be made (at block 640) whether changes in the signal strength data for the zones of interest are within a first range. For example, the processor 510 may compare the signal strengths in a plurality of measurements received for each zone of interest and determine whether the signal strengths are within the first range (e.g., as described below with reference to the first range 1010 of FIG. 10A) indicating that the water surface is still. Changes in the signal strength received from one or more light-based TOF sensors may indicate the water surface is moving due to the toilet being used by a person, the water surface is moving due to the flushing of the toilet, or the sensor enclosure 105 have moved due to the toilet seat being moved up or down.

When the changes in the signal strength data for the zones of interest are not within the first range, indicating that the water level is not still, the process 600 may proceed to block 630 that was described above. Otherwise, the zones of interest corresponding to the water surface may be updated (at block 642) based on the distance data received from the light-based TOF sensors (e.g., as described above with reference to blocks 615-625. The signal strengths from the zones of interest may be stored (at block 645) as the signal strength of the still water level. The calibration flag may be rest (at block 647). The process 600 may proceed to block 630 that was described above.

The following is a non-limiting example of the steps that may be performed by some embodiments in a calibration loop around block 640-647 of FIG. 6B.

Calibration Loop

Calibration Loop Start

Run a plurality of cycles with small time delay between runs:
Poll zones of interest data (i.e., data related to the light reflected from the water surface)
Extract signal strength values per each zone of interest
Check that zone of interest data is valid
Filter the zone of interest signal strength and distance values
Accumulate data and calculate running average
Repeat calibration loop until the values are normalized and the deviation between new values and running average is minimal
If zones of interest values show minimal deviation or change, “still water” is detected, indicating toilet water has settled at a certain level
Set the accumulated average values for the zone of interest distance and zone of interest signal strength as the “calibration point”
Set the calibration flag

Exit the calibration loop

When a determination is made (at block 635) that the calibration is performed to store signal strengths for the still water from the zones of interest, a determination may be made (at block 650) whether the pressure sensor readings have changed. For example, the processor 510 may receive measurements from the pressure sensor 104 and may determine that the pressure sensor measurements have changed more than a threshold. Since the pressure sensor 104 is positioned below the toilet seat, a change in the pressure measurements may indicate the toilet seat has changed position. For example, the toilet seat may have changed position from being up to being down, or vice versa.

If yes, the process 600 may proceed to block 640, which is described below. For example, since changing the position of the toilet seat may move the toilet training device, proceeding to blocks 640-647 may allow updating the zone of interest based on distance measurements and updating the signal strength measurements from the zones of interest.

When a determination is made (at block 650) that the pressure sensor readings have not changed, the new signal strength data from the zones of interest are added (at block 655) to a running average of the signal strength data from the zones of interest. For example, the processor 510 may use the data received (at block 630) to continually update the running average of the signal strength data from the zones of interest.

Once the signal strength levels are stored for the zone of interest (e.g., for the still water level) and the pressure sensor reading does not indicate a change in the seat position (e.g., indicating that the toilet training device is stable) a determination has to be made whether the water level is moving. When the water level is moving, a determination has to be made whether the move is due to the dropping of excrement in the bowl or due to the flushing the toilet.

FIGS. 10A-10C are graphs showing changes in the signal strength measurements received from the zones of interest that may indicate still water, water disturbance due to the use of the toilet, or water disturbance due to flushing of the toilet, according to various aspects of the present disclosure.

With reference to FIG. 9A, the first signal strength range 1010 may include an upper threshold 1011 and a lower threshold 1012. When the changes in the signal strength measurements (as shown by 1030) from all zones of interest 810 (FIG. 9) are within the first range 1010, the water level is still.

With reference to FIG. 9B, the second signal strength range 1020 may include an upper threshold 1021 and a lower threshold 1022. When the changes in the signal strength measurements (as shown by 1040) from at least some of the zones of interest 810 (FIG. 9) are outside the first range 1010 but no changes in the signal strength measurement is outside the second range 1020, the change in the water level may indicate the dropping of human waste into the toilet bowl.

With reference to FIG. 9C, when the changes in the signal strength measurements (as shown by 1050) from at least some of the zones of interest 810 (FIG. 9) are outside the second signal strength range 1010, the change in the water level may indicate the flushing of the toilet bowl. In other words, flushing the toilet causes more disturbances in the water level than the dropping of human excrement in the toilet bowl.

Referring back to FIGS. 6A-6C, the changes between the new signal strength measurements from the zones of interest and the corresponding running average of the signal strengths may be calculated (at block 660). A determination may be made (at block 662) whether the difference between the new zones of interest signal strength data and the running average signal strength data is within the first range. For example, the first range 1010 may include an upper threshold 1011 and a lower threshold 1012 as shown in FIG. 10A. If yes, the water level is still and the process 600 may process to block 690, which is described below.

Otherwise, a determination may be made (at block 665) whether the difference between the new zones of interest signal strength data and the average data are within a second range. For example, the second range 1020 may include an upper threshold 1021 and a lower threshold 1022 as shown in FIG. 10B. If yes, the water level disturbances indicate the toilet is being used by a person (e.g., the toilet bowl is receiving human waste) and the process 600 may proceed to block 675, which is described below.

Otherwise, the water level disturbances indicate the toilet is flushed and the process 600 may proceed to block 670. In addition to, or in lieu of, determining whether the difference between the new zones of interest signal strength data and the average data are within the second range, some embodiments may determine that the toilet is being flushed by using signal strength measurements from the walls of the bowl that may be outside of the zones of interest. For example, during flushing, water may be coming down the walls of the bowl, resulting in a significant amount of change in the signal strength measurements from the areas that are outside the zones of interest (e.g., areas outside the zones of interest 815 of FIGS. 8-9).

At block 670, LED on and off patterns and one or more soundtracks may be selected to reward the person for flushing the toilet. The process 600 may proceed to block 680, which is described below. When a determination is made (at block 665) that the difference between the new zones of interest signal strength data and the average data are within a second range, LED on and off patterns and one or more soundtracks may be selected (at block 675) to reward the person for the proper use of the toilet (e.g., the proper releasing of the human waste in the toilet bowl). The LED on and off patterns and/or the soundtrack(s) selected for flushing the toilet and the proper use of the toilet may be the same or may be different in different embodiments.

The actuation timer may be started (at block 680). The actuation timer may be used to allow the LED patterns and the soundtrack(s) to be played for the duration of the actuation timer even when the water level becomes still. The actuation timer may begin or restarted each time block 680 is performed.

The LED pattern display and soundtrack(s) play may start (at block 685) by turning LEDs on and off, displaying different colors and different patterns by the multicolor LEDs, starting soundtrack(s) playback, enabling peripheral devices, and enabling applications (e.g., applications on external electronic devices, such as, smartphones, tablet computers, laptop computers, desktop computers, etc., or software applications in peripheral devices). The process 600 may then proceed to block 630, which was described above.

The following is a non-limiting example of the steps that may be performed by some embodiments in block 685 of FIG. 6C to start actuation.

Begin Actuation

Begin LED light show
Cycle through multiple colors if multicolored LED's are used else flash single colored LED's

Play sound/s on speaker(s)

Enable optional rotating lights

Send command (e.g., over Bluetooth, Wi-Fi, or X-bee) to activate peripheral devices/applications

When a determination is made (at block 662) that the difference between the new zones of interest signal strength data and the running average signal strength data is within the first range, a determination may be made (at block 690) whether the activation timer is active. If yes, the process 600 may proceed to block 630, which was described above. Otherwise, the actuation may be ended (at block 695) by turning the LEDs off, stopping the soundtracks) playback, disabling peripheral devices, and disabling the applications. The latest zones of interest signal strengths may be stored (at block 697) as the signal strength of the still water level. The process 600 may then proceed to block 630, which was described above.

The following is a non-limiting example of the steps that may be performed by some embodiments in block 695 of FIG. 6C to stop actuation.

Stop Actuation

Stop LED light show

Stop playing sound on speaker(s)

Stop the optional rotating lights

Send command (e.g., over Bluetooth, Wi-Fi, or X-bee) to deactivate peripheral devices and applications

The following is a non-limiting example of the steps that may be performed by some embodiments in the process of FIGS. 6A-6C after the initialization is completed.

Run Program

Each light-based TOF sensor is referred to as a zone.

Start polling all zones and acquiring distance from the TOF sensors to the nearest object

Generate a contour map of all zones with zone distance data

Detect location of toilet water by detecting the lowest flat points on the contour map (the valley)

Set up filter to polling the light-based TOF sensors “zone of interest” or “zones of interest” that is/are centered on the toilet water

Start polling each zone of Interest

Calculate or obtain: Distance from TOF sensors to the toilet water, TOF sensor signal strength, ambient noise per TOF sensor, estimated reflectance and validity of TOF sensor data per TOF sensor or per group of TOF sensors

If calibration on the zones of interest data has not been performed (check calibration flag) or if seat pressure sensor has been depressed: Go to Calibrate

Resume normal polling of the zone data

Get new zone data and add it to the running average of zone data (i.e., filter zone data)

If zone data deviates from calibration point by n margin:
Check if zone data deviation is much larger than Calibration point+n margin
   Check if zones that are not being polled detect movement as well i.e., water along the walls of the toilet
   Toilet Flush event has occurred—Go to Calibration Loop
Go to Begin Actuation
Start a timer for x seconds

Resume normal polling of zone data

Continue accumulating running average of zone data over n samples

If new zone data is close to running average zone data and the timer has reached x seconds
Go to Stop Actuation

Set new running average data point as the new “Calibration Point”—indicating new level of Still toilet water

Else if new zone data deviates from the calibration point by a specified margin:

Reset the timer

Loop back to beginning

The specific operations of the process 600 may not be performed in the exact order shown and described. Furthermore, the specific operations described with reference to FIGS. 6A-6C may not be performed in one continuous series of operations in some embodiments, and different specific operations may be performed in different embodiments. For example, some aspects of the present embodiments may only determine whether excrement is released into the toilet bowl but may not determine the toilet is flushed. These embodiments may only compare the changes in the signal strength measurements against the first signal strength range 1010 of FIG. 1010 and may determine that the excrement is released into the toilet bowl if at least some of the signal strength measurements are outside the first range 1010. These embodiments may not perform blocks 665-670 of FIG. 6C.

### Alternative Embodiments

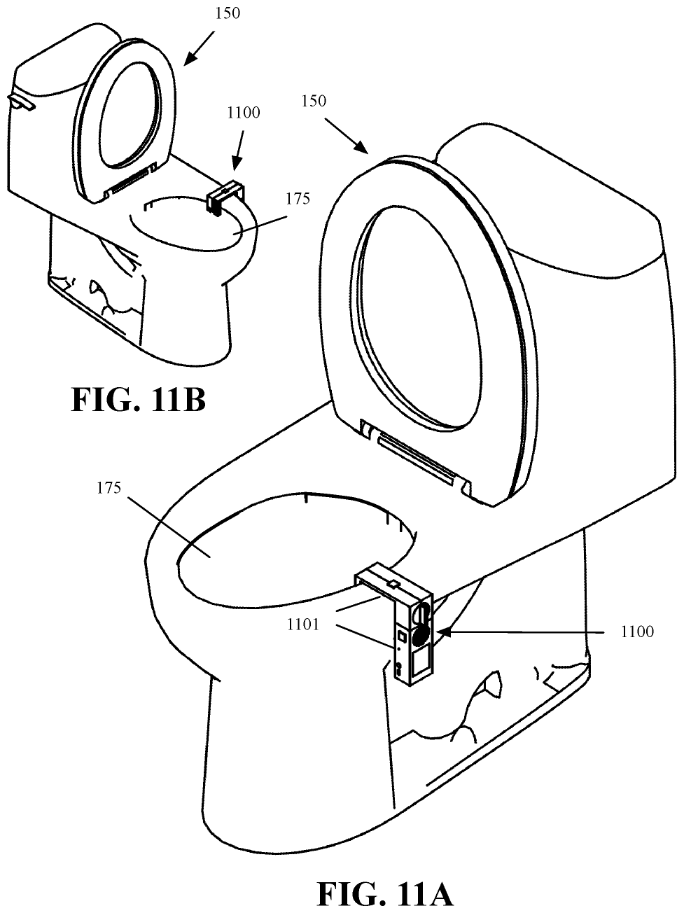

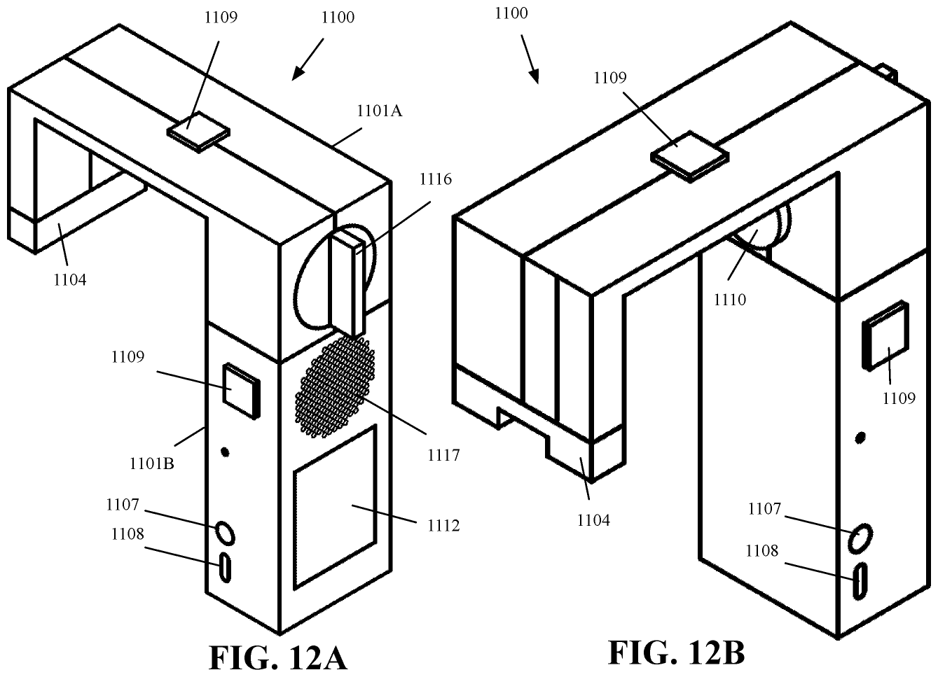

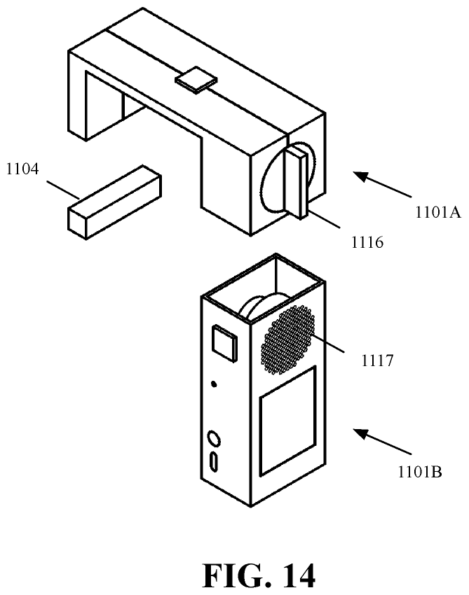

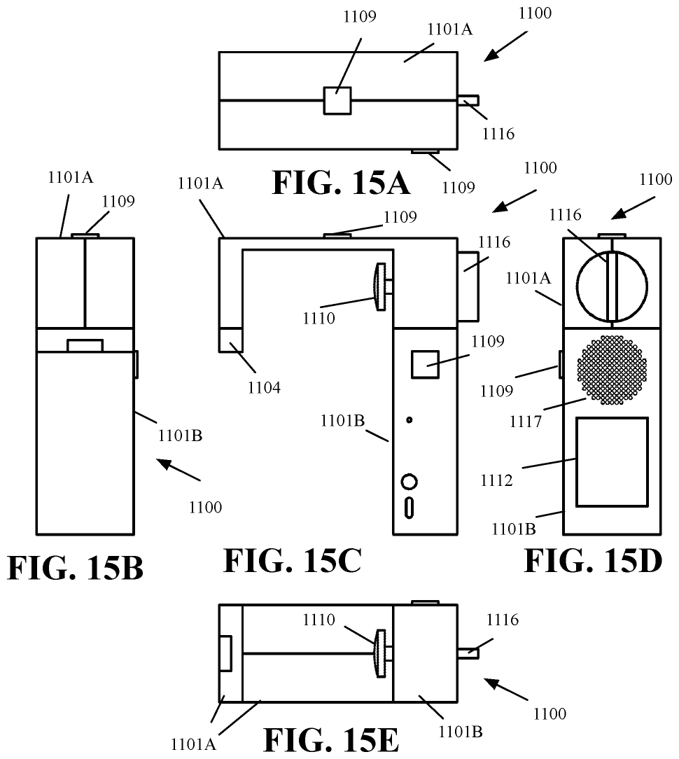

Several alternative embodiments are described below. Some of the present embodiments provide a toilet training device for either male or female users. There is no age limit for this device. FIG. 11A is a right perspective view and FIG. 11B is a left perspective view of a toilet-training device used in a toilet bowl, according to various aspects of the present disclosure. FIG. 12A and FIG. 12B illustrate right perspective views of the toilet training device, according to various aspects of the present disclosure. FIG. 13 illustrates an exploded view of the toilet training device, according to various aspects of the present disclosure. FIG. 14 illustrates different housing components of the toilet training device, according to various aspects of the present disclosure. FIG. 15A illustrates the top view, FIG. 15B illustrates the back elevation view, FIG. 15C illustrates the left elevation view, FIG. 15D illustrates the front elevation view, and FIG. 15E illustrate the bottom view of the toilet training device, according to various aspects of the present disclosure.

With reference to FIGS. 11A-11B, 12A-12B, 13-14, and 15A-15E, the toilet-training device 1100 may be housed within a housing 1101. The housing 1101 may be attached to a toilet 150. The toilet-training device 1100 may function by first being securely attached to an off-the-shelf toilet 150 (as shown in FIGS. 11A-11B), with the head of the sensor 1103 that is used to detect whether the toilet being used facing the inside of the bowl 175. The toilet-training device housing 1101 may secure the device 1100 onto the toilet 150. The housing 1101 may be designed to house the device electronics, allowing for swapping out of sensors, actuators, and batteries, while providing safe operation of the device 1100 in its intended environment.

With references to FIG. 13, the device housing 1101 may include a top mechanical enclosure 1101A and a base mechanical enclosure 1101B. The toilet training device 1100 may include one or more single and/or multicolored LEDs 1102, one or more waste (or excrement) detection sensors 1103, a detachable sensor housing unit 1104, a controller board 1105, one or more status indicator lights 1106, one or more buttons 1107, a connection port 1108, one or more optical or ultrasonic sensors 1109, a speaker 1110, a battery pack or a power supply 1111, and/or a display screen 1112.

The device 1100 and the housing 1101 are designed for easy attachment and detachment of various heads (sensor units) or various LED actuators. The waste detection sensor(s) 1103, in some embodiments, may be included in a sensor housing unit 1104. The terms waste or excrement is used herein to refer to both urine and feces. The sensor housing unit 1104 may be detachable from the top mechanical enclosure 1101A to swap different waste detection sensors. After the toilet training device 1100 is installed on a toilet, the waste detection sensor(s) 1103 may face the inside of the bowl 175.

The waste detection sensors 1103, in some embodiments, may include TOF sensors that may be used to detect if a person is releasing urine or feces into a toilet. A TOF sensor may use light (e.g., infrared laser light that may be invisible to human eyes) to provide depth information.

The TOF sensor(s) of the present embodiments may emit light signals, which may hit the top surface of the water in the toilet bowl 175. As shown in FIGS. 11A and 11B, the toilet training device 1100 may be installed such that the TOF sensor(s) may be positioned inside or right above the toilet bowl 175, facing downward towards the water surface at the bottom of the toilet bowl. The light emitted by the TOF sensor(s) may hit the water surface and may return to the TOF sensor(s). The time it takes for the light to bounce back is then measured to provide depth-mapping capabilities.

The controller board 1105 may include a processor (e.g., a microprocessor or a microcontroller) and computer readable media (e.g., volatile memory and non-volatile memory) to store data and/or computer readable instructions. The computer readable media may be non-transitory computer readable media. The computer readable media may include different types of memory units, such as, read-only-memory, volatile read-and-write memory, and/or non-volatile read-and-write memory. The read-only-memory may store static data and instructions that are needed by the processor. The non-volatile read-and-write memory may store instructions and data even when the power to the non-volatile memory is off.

The volatile read-and-write memory device may be random access memory and may be used as system memory. The system memory may store some of the instructions and data that the processor needs at runtime. In some embodiments, the processes of the present embodiments may be stored in the system memory, the non-volatile memory, and/or the read-only memory. From these various memory units, the processor may retrieve instructions to execute and data to process in order to execute the processes of some embodiments.

The processor of the toilet training device 1100 may use the TOF sensor(s) readings to map out the area of view of the sensor(s) into several regions. The processor may analyze the TOF sensor(s)′ readings and may detect any disturbances in a region. The processor may use the results of the analysis of the disturbances in the water and may detect whether the toilet is in use or whether the toilet has been flushed. The processor may examine the disturbances in the water. The TOF sensor(s) of the present embodiments provide the technical advantage of detecting the disturbance of water in the toilet bowl that may be used to detect whether the toilet is in use or if the toilet has been flushed. In contrast, the prior art toilet training devices use weight measurement sensors or sensors that detect whether the bodily waste has passed in front of the sensor to determine whether the toilet has been used. In addition, the prior art toilet training devices have to use different sensors for detecting the excrement and detecting whether the toilet is flushed. The processor may also use multiple sensors on the device to determine more accurately when the toilet is in use and when there is a spurious event.

The sensors and the LEDs may be controlled via the processor located on the controller board 1105. The processor may wirelessly communicate with one or more external devices, such as smartphones, tablets, actuators, servers, etc. The status indicator light(s) 1106 may indicate multiple device modalities in addition to on and off. The controller board 1105, in some embodiments, may include one or more buttons 1107 and a connection port 1108, such as a universal serial bus (USB) port. In addition to the waste detection sensor(s) 1103, the toilet training device 1100 device may optionally include optical or ultrasonic sensors 1109 to detect an approaching person or if the toilet lid is up or down. The toilet training device 1100 device may include one or more speakers 1110 to play sound (e.g., play music, play tunes, play spoken words) to interact with the user. The toilet training device 1100 device may include a grille 1117 to allow the speaker(s) 1110 sound to exit the base mechanical enclosure 1101B. The power for the electronics onboard the toilet training device 1100 may be supplied by a battery pack or a power supply 1111, which may include one or more batteries, or a power converter to be used with an external power supply.

The toilet training device 1100 may include a display screen, such as an LCD screen 1112 to provide a user with additional functionality. The LCD screen, in some embodiments, may be touch sensitive. The speaker 1110, the battery pack (or power supply) 1111, the display screen 1112, the button(s) 1107, and the controller board 1105 along with other related components may be housed within the base mechanical enclosure 1101B of the housing 1101. The housing 1101 may be mechanically attached to the toilet 150 and kept in place while in use. The housing 1101, in some embodiments, may be mechanically attached to the toilet 150 with a clamp that may be tightened with a knob 1116 to secure the housing 1101 on the rim of the toilet 150.

The toilet training device 1100, in some embodiments, may be enabled via the activation switch 1107 (e.g., and without limitations, a push button). Once enabled, the sensor(s) 1103 may continually scan the toilet bowl 175 to detect usage. If proper toilet usage has been detected, the device 1100 may enable various forms of actuation as part of a reward-based program.

These actuations may include one or more of the followings. Enabling and disabling light emitting diodes (LED) lighting inside and outside the toilet bowl 175; enabling and disabling sound and music from the device 1100; enabling/disabling an application running on a wireless device (e.g., a smartphone or tablet) via wire or wirelessly; and enabling and disabling a wireless device (e.g., a toy, or other animatronic object, etc.), via wire or wirelessly.

With reference to FIG. 4, the detachable sensor housing unit 1104 may be attached and detached from the top mechanical enclosure 1101A. This scheme allows a person to swap sensors by replacing the detachable sensor housing unit 1104 with another detachable sensor housing unit. The base mechanical enclosure 1101B, in some embodiments, may have a removable cover which may be removed for service or battery change.

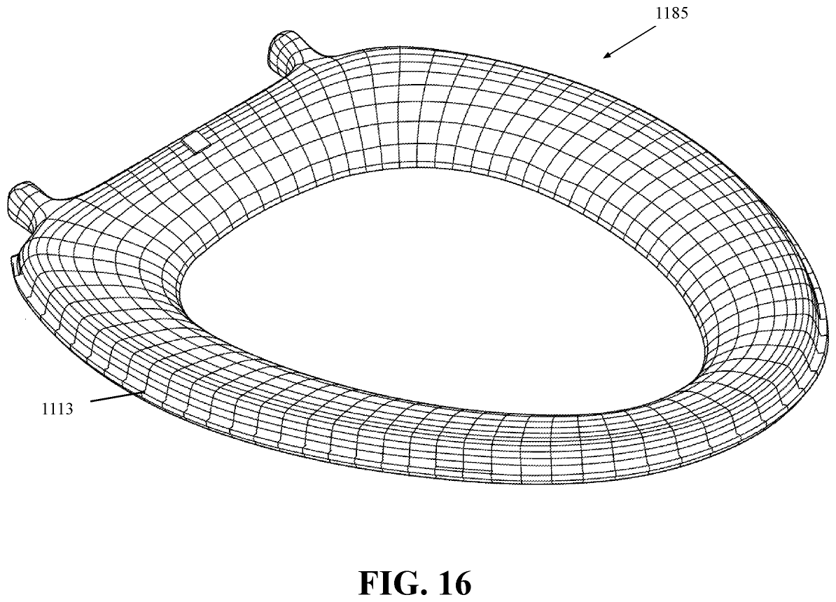

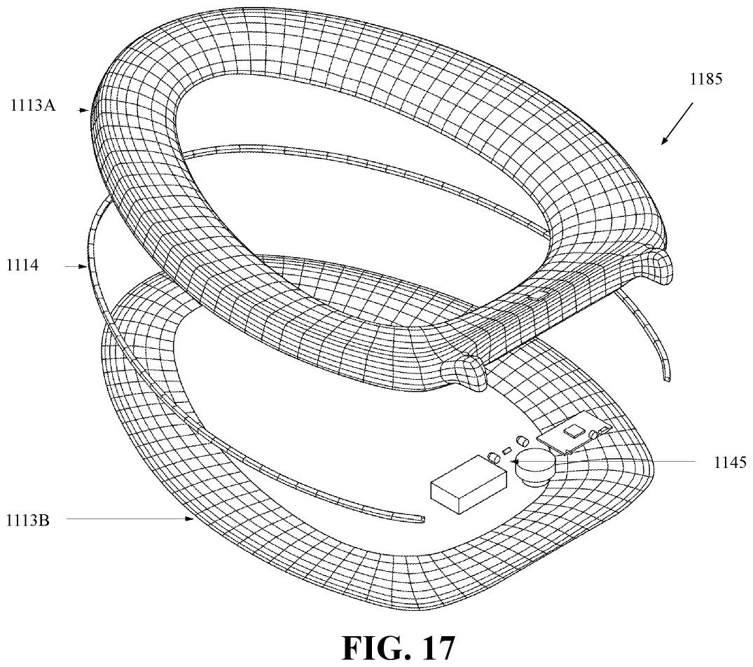

Instead of the housing 1101 described above, some embodiments may include the toilet training device in a toilet seat that may be added as a retrofit toilet seat to an off-the-shelf toilet. FIG. 16 is a perspective view of an alternative embodiment that includes the toilet training device embedded into a toilet seat 1113, according to various aspects of the present disclosure. FIG. 17 illustrates an exploded view of the toilet training device of FIG. 16, according to various aspects of the present disclosure. With reference to FIGS. 16 and 17, the toilet training device 1185 may include a toilet seat 1113 (FIG. 16) that may be used as a replacement toilet seat. For example, the toilet seat of an existing toilet bowl may be removed and the toilet seat 1113 may be attached to a toilet bowl. The toilet seat 1113, in some embodiments, may be bolted onto the existing toilet bowl. The retrofit toilet seat 1113 functions in both up and down positions. The retrofit toilet seat 1113 may function as a normal toilet seat when not in use for toilet training.

With reference to FIG. 17, the toilet training device 1185 may include a top cover 1113A, a continuous multicolored group of LEDs 1114 that emits diffused light outside of the toilet bowl, and electronics 1145 such as sensor(s), controller board, etc, and a bottom cover 1113B. The electronics 1145 as well as the group of LED 1114 may be secured and enclosed within the top cover 1113A and the bottom cover 1113B.

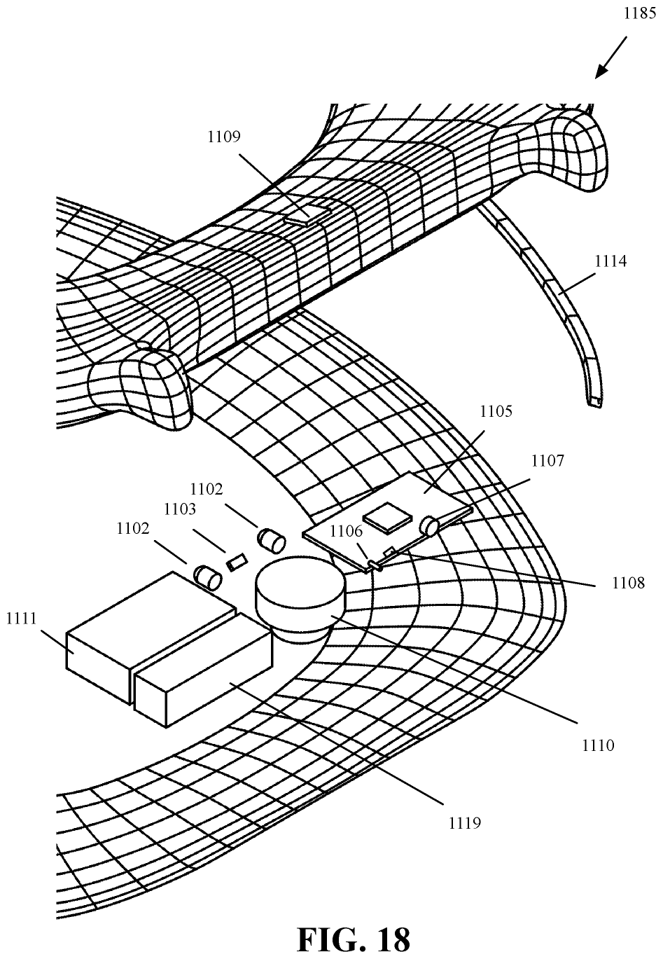

FIG. 18 provides details of the electronics 1145 of the toilet training device of FIG. 17, according to various aspects of the present disclosure. With reference to FIG. 18, the toilet training device 1185 may include one or more waste detection sensors 1103 (e.g., ultrasonic sensor(s) or optical sensor(s)). The toilet training device may include several single and/or multi-colored LEDs 1102 that may be used to emit light into and/or outside the toilet bowl. The toilet training device 1185 may include a battery pack or a power supply 1111 that may include one or more batteries or a power converter to be used with an external power supply.

The toilet training device 1185 may also include a speaker 1110 to play sound or music to interact with the user. The toilet training device 1185 may also optionally include additional optical or ultrasonic sensors 1109 to detect an approaching person or if the toilet lid is up or down. The toilet training device 1185 may include an optional seat vibrator 1119 that may provide haptic feedback. The status indicator light(s) 1106 may indicate multiple device modalities in addition to on and off. The sensors and the LEDs may be controlled by a controller board 1105. The controller board 1105 may include a processor, computer readable media, and one or more wireless transceivers, such as Wi-Fi, Bluetooth, and/or other wireless communication transceivers, to wirelessly communicate with one or more electronic devices. The controller board 1105, may optionally include a power button 1107.

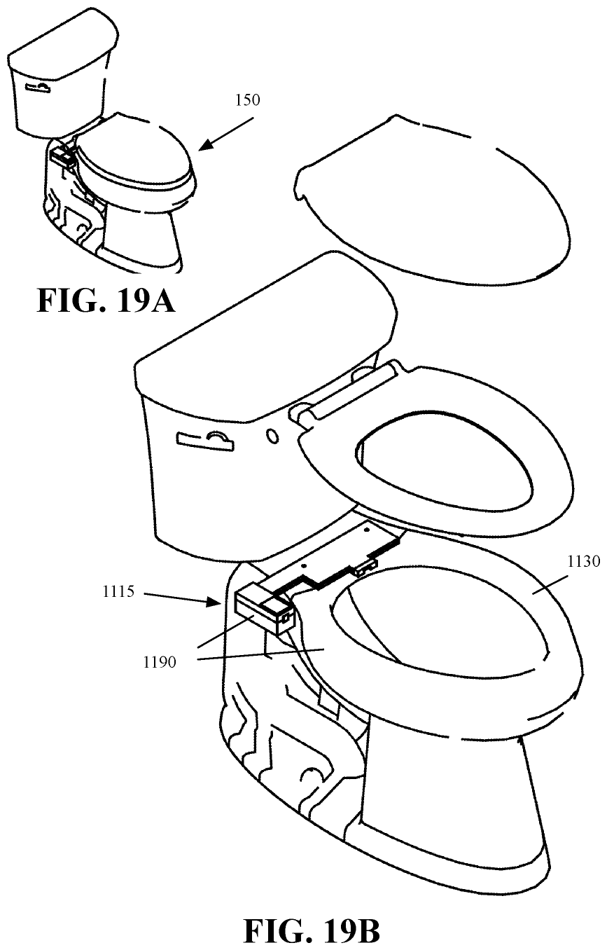

FIG. 19A illustrates a perspective view and FIG. 19B illustrates an exploded view of an alternative embodiment of the toilet training device 1190 that includes a housing 1115 and a toilet seat retrofit 1130, according to various aspects of the present disclosure. The embodiment of FIGS. 19A-19B may be attached to an existing toilet bowl 150 by removing the lid and seat of the toilet bowl. After the removal, the toilet training device may be lined up with the bowl, seat, and lid mounting holes and fastened with bolts.

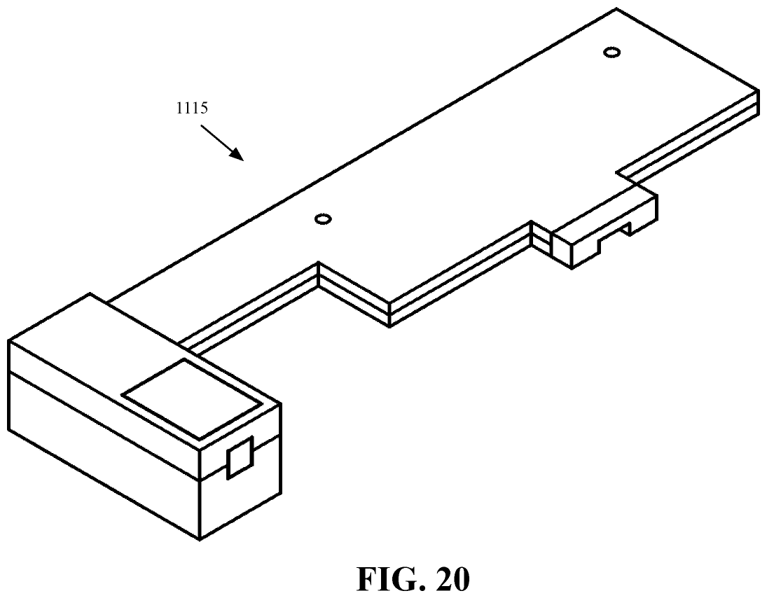

FIG. 20 illustrates a perspective view of the housing 1115 of the toilet training device of FIGS. 19A-19B, according to various aspects of the present disclosure. The toilet training device is designed for easy attachment/detachment of various heads (sensor units) or various LED actuators.

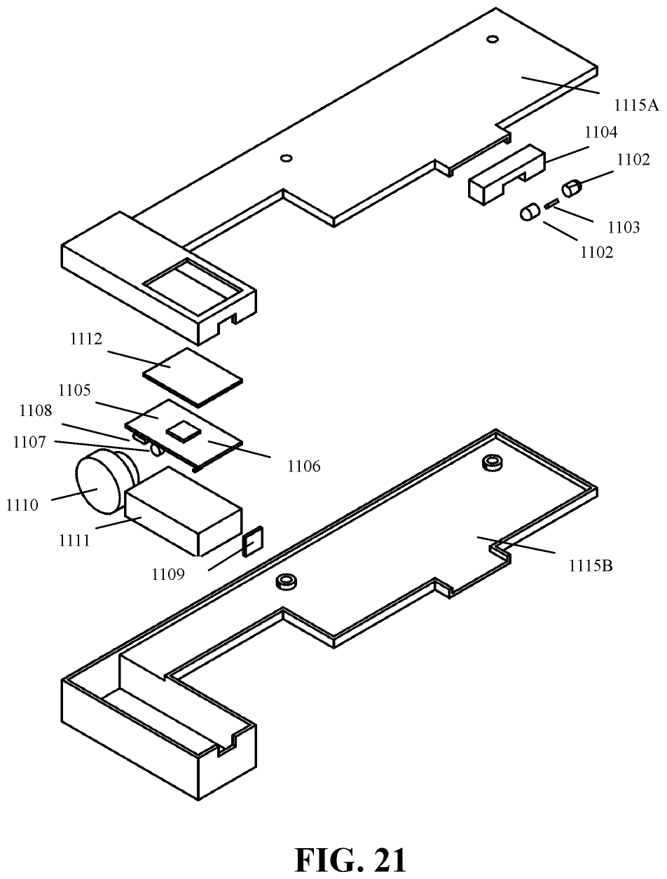

FIG. 21 illustrates an exploded view of the electronic components of the toilet training device of FIGS. 19A-19B, according to various aspects of the present disclosure. The electronic components may be housed in the housing (or mechanical enclosure) 1115. The toilet training device may include one or more of the following elements. Two or more single and/or multi-colored LEDs 1102 and one or more waste detection sensors 1103. The waste detection sensors 1103, in some embodiments, may be swapped out to different sensor(s) along with the detachable sensor housing unit 1104.

The sensors and the LEDs may be controlled by a controller board 1105. The controller board 1105 may include a processor (e.g., a microcontroller or a microprocessor) and one or more memory units. The controller board 1105 may include one or more wireless transceivers such as, Wi-Fi, Bluetooth, and/or other wireless communication transceivers. The wireless communication connectivity may allow the device to connect to an electronic device, such as a smartphone, a tablet, or other wireless devices for communicating usage data and analytics, and for controlling peripheral devices and/or the toilet training device.

The status indicator light 1106 may indicate multiple device modalities in addition to on and off. The controller board 1105 may also include of one or more buttons 1107 and a connection port 1108, such as a USB port. In addition to the waste detection sensor(s) 1103, the toilet training device may optionally include additional optical or ultrasonic sensors 1109 to detect an approaching person or if the toilet lid is up or down.

The toilet training device may include a speaker 1110 to play sound or music to interact with the user. The electronics onboard the toilet training device may be powered by a battery pack or a power supply 1111, which may include one or more batteries or a power converter to be used with an external power supply. The toilet training device may include a display screen 1112, such as an LCD screen to provide the user with additional functionality. The LCD screen 1112, in some embodiments, may be touch sensitive. The Speaker, battery, LCD, buttons, and controller board along with other related components may be housed within the base mechanical enclosure 1115B. The base bae mechanical enclosure may be mechanically attached to the toilet mechanically attached to the toilet and kept in place while in use.

As used in this disclosure and any claims of this disclosure, the terms such as “processing unit,” “processor,” “controller,” “microcontroller,” “server”, and “memory” all refer to electronic or other technological devices. These terms exclude people or groups of people. For the purposes of this disclosure, the terms display or displaying means displaying on an electronic device. As used in this disclosure and any claims of this disclosure, the terms “computer readable medium,” “computer readable media,” and “machine readable medium” are entirely restricted to non-transitory, tangible, physical objects that store information in a form that is readable by a processing unit. These terms exclude any wireless signals, wired download signals, and any other ephemeral or transitory signals.

In a first aspect, a toilet training device is provided. The toilet training device comprises a processor; a housing encompassing the processor; a plurality of light-based time of flight (TOF) sensors; a plurality of light emitting diodes (LEDs); a sensor enclosure encompassing the plurality of light-based TOF sensors; and a clip attached to the housing and the sensor enclosure. The clip is configured to attach to a rim of a toilet bowl pointing the light-based TOF sensors towards a water surface inside the toilet bowl. Each light-based TOF sensor is configured to project a plurality of light beams towards the toilet bowl; receive light reflected from an object in a path of the light beams; make measurements of a distance between the light-based TOF sensor and the nearby object; and make measurements of a signal strength of the reflected light. The processor is configured to generate a contour map from the distant measurements by the plurality of light-based TOF sensors; identify one or more zones of interest as the water surface based on the distant measurements; identify changes in the signal strength measurements; determine excrement is released in the toilet bowl when at least some of the changes in the signal strength measurements are outside a signal strength range; and turn the LEDs on and off a plurality of times in response to determining the excrement is released in the toilet bowl.

An embodiment of the first aspect further comprises one or more speakers, where the processor is configured to play sound comprising one or more of music, a plurality of tunes, and spoken words through the speaker in response to determining the excrement is released in the toilet bowl.

In an embodiment of the first aspect, at least a set of LEDs in the plurality of the LEDs are positioned on a motorized LED ring of the toilet training device, where the processor is configured to rotate the motorized ring in response to determining the excrement is released in the toilet bowl.

In another embodiment of the first aspect, the signal strength range is a first signal strength range, the processor is configured to determine the excrement is released in the toilet bowl when the changes in the signal strength measurements are inside a second range and at least some of the changes in the signal strength measurements are outside the first range, wherein the first range is within the second range; determine the toilet bowl is flushed when at least some of the changes in the signal strength measurements are outside the second range; and turn the LEDs on and off a plurality of times in response to determining the toilet bowl is flushed.

In another embodiment of the first aspect, at least a set of LEDs in the plurality of the LEDs are covered by a light diffuser and light reflector.

In another embodiment of the first aspect, the light reflector is rotatable.

In another embodiment of the first aspect, the light reflector is a motorized rotatable light reflector, where the processor is configured to rotate the motorized rotatable light reflector in response to determining the toilet is flushed.

In another embodiment of the first aspect, at least some of the LEDs are multicolor LEDs, where turning the LEDs on and off comprises displaying different colors and patterns by the multicolor LEDs.

In another embodiment of the first aspect, the processor is configured to display a first set of colors and patterns by the multicolor LEDs in response to determining the excrement is released in the toilet bowl, wherein the processor is configured to display a second set of colors and a patterns by the multicolor LEDs in response to determining the toilet bowl is flushed, and wherein the first and second sets are different.

Another embodiment of the first aspect further comprises one or more speakers; where the processor is configured to play sound comprising one or more of music, a plurality of tunes, and spoken words through the speaker in response to determining the excrement is released in the toilet bowl or the toilet is flushed.

In another embodiment of the first aspect, the processor is configured to play different sounds in response to determining the excrement is released in the toilet bowl or the toilet is flushed.

In another embodiment of the first aspect, the clip comprises first and second ends, wherein the first end comprises a first non-slip pad, where the second end comprises a second non-slip pad, and wherein the first and second non-slip pads are configured to hold to the rim of the toilet bowl.

Another embodiment of the first aspect further comprises a height adjustable retention tab connecting the sensor enclosure to the clip, where the height adjustable retention tab is configured to adjust a height of the sensor enclosure after the toilet training device is connected to the toilet rim.

Another embodiment of the first aspect further comprises a housing rotation mechanism connecting the housing to the clip, where the housing rotation mechanism is configured to rotate the housing after the toilet training device is connected to the toilet rim.

Another embodiment of the first aspect further comprises a pressure sensor connected to the clip, where the pressure sensor is configured to measure a pressured applied by a seat of the toilet; where the processor is configured to receive pressure measurements from the pressure sensor; in response to determining the pressure measurements have changed more than a threshold: update the contour map from the distant measurements by the plurality of light-based TOF sensors; and update the zones of interest as the water surface based on the distant measurements.

Another embodiment of the first aspect further comprises a transparent sensor enclosure cover configured to cover an opening of the sensor enclosure through which the light-based TOF sensors transmit light beams and receive light reflections, where the processor is configured to calibrate each of the plurality of light-based TOF sensors by: sending one or more signals to each of the plurality of light-based TOF sensors to transmit a light beam and receive the light reflection back; storing a time that the light is reflected back to the light-based TOF sensor; determining an offset of the reflected light and an angle of the reflected light; and calibrating the sensor's measurements for cross talk using the time the light is reflected back, the offset of the reflected light, and the angle of the reflected light.

In another embodiment of the first aspect, the light-based TOF sensors comprise one or more of infrared TOF sensors, visible or invisible laser based TOF sensors, light detection and ranging (LIDAR) sensors, and visible light TOF sensors.

In another embodiment of the first aspect, the light-based TOF sensors comprise one or more of Single Photon Avalanche Diode (SPAD) sensors, LIDARs, laser distance sensors, photodiodes, avalanche photodiodes, and phototransistors.

Another embodiment of the first aspect further comprises a wireless transceiver, where the processor is configured to send one or more signals to a peripheral device through the wireless transceiver to turn a plurality of LEDs of the peripheral device on or off a plurality of times in response to determining the excrement is released in the toilet bowl.

Another embodiment of the first aspect further comprises a wireless transceiver, where the processor is configured to send one or more signals to a peripheral device through the wireless transceiver to play sound comprising one or more of music, a plurality of tunes, and spoken words through a speaker of the peripheral device in response to determining the excrement is released in the toilet bowl.

The above description presents the best mode contemplated for carrying out the present embodiments, and of the manner and process of practicing them, in such full, clear, concise, and exact terms as to enable any person skilled in the art to which they pertain to practice these embodiments. The present embodiments are, however, susceptible to modifications and alternate constructions from those discussed above that are fully equivalent. Consequently, the present invention is not limited to the particular embodiments disclosed. On the contrary, the present invention covers all modifications and alternate constructions coming within the spirit and scope of the present disclosure. For example, the steps in the processes described herein need not be performed in the same order as they have been presented, and may be performed in any order(s). Further, steps that have been presented as being performed separately may in alternative embodiments be performed concurrently. Likewise, steps that have been presented as being performed concurrently may in alternative embodiments be performed separately.

What is claimed is:

1. A toilet training device, comprising:
a processor;
a housing encompassing the processor;
a plurality of light-based time of flight (TOF) sensors;
a plurality of light emitting diodes (LEDs);
a sensor enclosure encompassing the plurality of light-based TOF sensors; and
a clip attached to the housing and the sensor enclosure;
wherein the clip is configured to attach to a rim of a toilet bowl pointing the light-based TOF sensors towards a water surface inside the toilet bowl;
wherein each light-based TOF sensor is configured to:
project a plurality of light beams towards the toilet bowl;
receive light reflected from an object in a path of the light beams;
make measurements of a distance between the light-based TOF sensor and the nearby object; and
make measurements of a signal strength of the reflected light;
wherein the processor is configured to:
generate a contour map from the distant measurements by the plurality of light-based TOF sensors;
identify one or more zones of interest as the water surface based on the distant measurements;
identify changes in the signal strength measurements;
determine excrement is released in the toilet bowl when at least some of the changes in the signal strength measurements are outside a signal strength range; and
turn the LEDs on and off a plurality of times in response to determining the excrement is released in the toilet bowl.

2. The toilet training device of claim 1 further comprising:
one or more speakers;
wherein the processor is configured to play sound comprising one or more of music, a plurality of tunes, and spoken words through the speaker in response to determining the excrement is released in the toilet bowl.

3. The toilet training device of claim 1, wherein at least a set of LEDs in the plurality of the LEDs are positioned on a motorized LED ring of the toilet training device, wherein the processor is configured to rotate the motorized ring in response to determining the excrement is released in the toilet bowl.

4. The toilet training device of claim 1, wherein the signal strength range is a first signal strength range, wherein the processor is configured to:
determine the excrement is released in the toilet bowl when the changes in the signal strength measurements are inside a second range and at least some of the changes in the signal strength measurements are outside the first range, wherein the first range is within the second range;
determine the toilet bowl is flushed when at least some of the changes in the signal strength measurements are outside the second range; and
turn the LEDs on and off a plurality of times in response to determining the toilet bowl is flushed.

5. The toilet training device of claim 4, wherein at least a set of LEDs in the plurality of the LEDs are covered by a light diffuser and light reflector.

6. The toilet training device of claim 5, wherein the light reflector is rotatable.

7. The toilet training device of claim 5, wherein the light reflector is a motorized rotatable light reflector, wherein the processor is configured to rotate the motorized rotatable light reflector in response to determining the toilet is flushed.

8. The toilet training device of claim 4, wherein at least some of the LEDs are multicolor LEDs, wherein turning the LEDs on and off comprises displaying different colors and patterns by the multicolor LEDs.

9. The toilet training device of claim 8, wherein the processor is configured to display a first set of colors and patterns by the multicolor LEDs in response to determining the excrement is released in the toilet bowl, wherein the processor is configured to display a second set of colors and a patterns by the multicolor LEDs in response to determining the toilet bowl is flushed, and wherein the first and second sets are different.

10. The toilet training device of claim 1 further comprising:
one or more speakers;
wherein the processor is configured to play sound comprising one or more of music, a plurality of tunes, and spoken words through the speaker in response to determining the excrement is released in the toilet bowl or the toilet is flushed.

11. The toilet training device of claim 10, wherein the processor is configured to play different sounds in response to determining the excrement is released in the toilet bowl or the toilet is flushed.

12. The toilet training device of claim 1, wherein the clip comprises first and second ends, wherein the first end comprises a first non-slip pad, wherein the second end comprises a second non-slip pad, and wherein the first and second non-slip pads are configured to hold to the rim of the toilet bowl.

13. The toilet training device of claim 1 further comprising a height adjustable retention tab connecting the sensor enclosure to the clip, wherein the height adjustable retention tab is configured to adjust a height of the sensor enclosure after the toilet training device is connected to the toilet rim.

14. The toilet training device of claim 1 further comprising a housing rotation mechanism connecting the housing to the clip, wherein the housing rotation mechanism is configured to rotate the housing after the toilet training device is connected to the toilet rim.

15. The toilet training device of claim 1 further comprising a pressure sensor connected to the clip;
wherein the pressure sensor is configured to measure a pressured applied by a seat of the toilet;
wherein the processor is configured to:
receive pressure measurements from the pressure sensor;
in response to determining the pressure measurements have changed more than a threshold:
update the contour map from the distant measurements by the plurality of light-based TOF sensors; and
update the zones of interest as the water surface based on the distant measurements.

16. The toilet training device of claim 1 further comprising a transparent sensor enclosure cover configured to cover an opening of the sensor enclosure through which the light-based TOF sensors transmit light beams and receive light reflections, wherein the processor is configured to calibrate each of the plurality of light-based TOF sensors by:
sending one or more signals to each of the plurality of light-based TOF sensors to transmit a light beam and receive the light reflection back;
storing a time that the light is reflected back to the light-based TOF sensor;
determining an offset of the reflected light and an angle of the reflected light; and
calibrating the sensor's measurements for cross talk using the time the light is reflected back, the offset of the reflected light, and the angle of the reflected light.

17. The toilet training device of claim 1, wherein the light-based TOF sensors comprise one or more of infrared TOF sensors, visible or invisible laser based TOF sensors, light detection and ranging (LIDAR) sensors, and visible light TOF sensors.

18. The toilet training device of claim 1, wherein the light-based TOF sensors comprise one or more of Single Photon Avalanche Diode (SPAD) sensors, LIDARs, laser distance sensors, photodiodes, avalanche photodiodes, and phototransistors.

19. The toilet training device of claim 1 further comprising a wireless transceiver, wherein the processor is configured to send one or more signals to a peripheral device through the wireless transceiver to turn a plurality of LEDs of the peripheral device on or off a plurality of times in response to determining the excrement is released in the toilet bowl.

20. The toilet training device of claim 1 further comprising a wireless transceiver, wherein the processor is configured to send one or more signals to a peripheral device through the wireless transceiver to play sound comprising one or more of music, a plurality of tunes, and spoken words through a speaker of the peripheral device in response to determining the excrement is released in the toilet bowl.
